(19) United States
(12) Patent Application Publication
(10) Pub. No.: US 2023/0370905 A1
(43) Pub. Date: Nov. 16, 2023

(54) SYSTEM AND METHOD FOR MAINTAINING MULTICAST BROADCAST SERVICE CONTINUITY IN IDLE AND INACTIVE STATES

(71) Applicant: TOYOTA JIDOSHA KABUSHIKI KAISHA, Toyota-shi, Aichi-ken (JP)

(72) Inventor: Alireza BABAEI, Fairfax, VA (US)

(73) Assignee: TOYOTA JIDOSHA KABUSHIKI KAISHA, Toyota-shi, Aichi-ken (JP)

(21) Appl. No.: 18/044,480

(22) PCT Filed: Sep. 9, 2021
(86) PCT No.: PCT/JP2021/033181

§ 371 Date: Mar. 8, 2023

Related U.S. Application Data
(60) Provisional application No. 63/076,704, filed on Sep. 10, 2020.

(51) Int. Cl. H04W 36/00; H04W 76/27; H04W 4/06; H04W 74/08

(52) U.S. Cl. CPC H04W 36/0007; H04W 76/27; H04W 4/06; H04W 74/0833

(57) ABSTRACT

A system, method and apparatus for mobile communications are provided. A user equipment (UE) in a radio resource control state receives a broadcast message that includes measurement configuration parameters. The UE determines, based on the measurement configuration parameters, a service continuity trigger for one or more multicast broadcast services (MBS) services. Responsive to the determined service continuity trigger, a random access process (RAP) is initiated, wherein initiating the RAP includes transmitting a first message indicating a request for MBS configuration parameters associated with the one or more MBS services. The UE receives the one or more MBS configuration parameters in response to transmitting the first message. The UE then receives data associated with the one or more MBS services via the target cell based on the MBS configuration parameters and while remaining in the RRC state.

### TECHNICAL FIELD

The disclosure relates to a method of maintaining service continuity.

### BACKGROUND ART

Generally described, computing devices and communication networks can be utilized to exchange information. In a common application, a computing device can request/transmit data with another computing device via the communication network. More specifically, computing devices may utilize a wireless communication network to exchange information or establish communication channels.

Wireless communication networks can include a wide variety of devices that include or access components to access a wireless communication network. Such devices can utilize the wireless communication network to facilitate interactions with other devices that can access the wireless communication network or to facilitate interaction, through the wireless communication network, with devices utilizing other communication networks.

### SUMMARY OF INVENTION

One of embodiments of the invention is a method of maintaining service continuity. The method comprises: receiving, by a user equipment (UE) in a radio resource control (RRC) state, a broadcast message comprising measurement configuration parameters, wherein the RRC state corresponds to at least one of an RRC inactive state and an RRC idle state; determining, based on the measurement configuration parameters, a service continuity trigger for one or more multicast broadcast services (MBS) services; based on the determined service continuity trigger, initiating a random access process (RAP), wherein initiating the RAP includes transmitting a first message indicating a request for MBS configuration parameters associated with the one or more MBS services; receiving the one or more MBS configuration parameters in response to transmitting the first message; and receiving data associated with the one or more MBS services via the target cell based on the MBS configuration parameters and while remaining in the RRC state.

### BRIEF DESCRIPTION OF DRAWINGS

FIG. 1 shows an example of a system of mobile communications according to some aspects of one or more exemplary embodiments of the present disclosure.

FIG. 2A and FIG. 2B show examples of radio protocol stacks for user plane and control plane, respectively, according to some aspects of one or more exemplary embodiments of the present disclosure.

FIG. 3A, FIG. 3B and FIG. 3C show example mappings between logical channels and transport channels in downlink, uplink and sidelink, respectively, according to some aspects of one or more exemplary embodiments of the present disclosure.

FIG. 4A, FIG. 4B and FIG. 4C show example mappings between transport channels and physical channels in downlink, uplink and sidelink, respectively, according to some aspects of one or more exemplary embodiments of the present disclosure.

FIG. 5A, FIG. 5B, FIG. 5C and FIG. 5D show examples of radio protocol stacks for NR sidelink communication according to some aspects of one or more exemplary embodiments of the present disclosure.

FIG. 6 shows example physical signals in downlink, uplink and sidelink according to some aspects of one or more exemplary embodiments of the present disclosure.

FIG. 7 shows examples of Radio Resource Control (RRC) states and transitioning between different RRC states according to some aspects of one or more exemplary embodiments of the present disclosure.

FIG. 8 shows example frame structure and physical resources according to some aspects of one or more exemplary embodiments of the present disclosure.

FIG. 9 shows example component carrier configurations in different carrier aggregation scenarios according to some aspects of one or more exemplary embodiments of the present disclosure.

FIG. 10 shows example bandwidth part configuration and switching according to some aspects of one or more exemplary embodiments of the present disclosure.

FIG. 11 shows example four-step contention-based and contention-free random access processes according to some aspects of one or more exemplary embodiments of the present disclosure.

FIG. 12 shows example two-step contention-based and contention-free random access processes according to some aspects of one or more exemplary embodiments of the present disclosure.

FIG. 13 shows example time and frequency structure of Synchronization Signal and Physical Broadcast Channel (PBCH) Block (SSB) according to some aspects of one or more exemplary embodiments of the present disclosure.

FIG. 14 shows example SSB burst transmissions according to some aspects of one or more exemplary embodiments of the present disclosure.

FIG. 15 shows example components of a user equipment and a base station for transmission and/or reception according to some aspects of one or more exemplary embodiments of the present disclosure.

FIG. 16A shows example RRC resumption procedures according to some aspects of one or more exemplary embodiments of the present.

FIG. 16B shows example RRC resumption procedures according to some aspects of one or more exemplary embodiments of the present

FIG. 16C shows example RRC resumption procedures according to some aspects of one or more exemplary embodiments of the present

FIG. 16D shows example RRC resumption procedures according to some aspects of one or more exemplary embodiments of the present

FIG. 16E shows example RRC resumption procedures according to some aspects of one or more exemplary embodiments of the present disclosure.

FIG. 17 shows example processes for service continuity in RRC Inactive and/or RRC Idles states.

FIG. 18 shows example processes for service continuity in RRC Inactive and/or RRC Idles states.

FIG. 19 shows an example process for service continuity in RRC Inactive and/or RRC Idles states.

### DESCRIPTION OF EMBODIMENTS

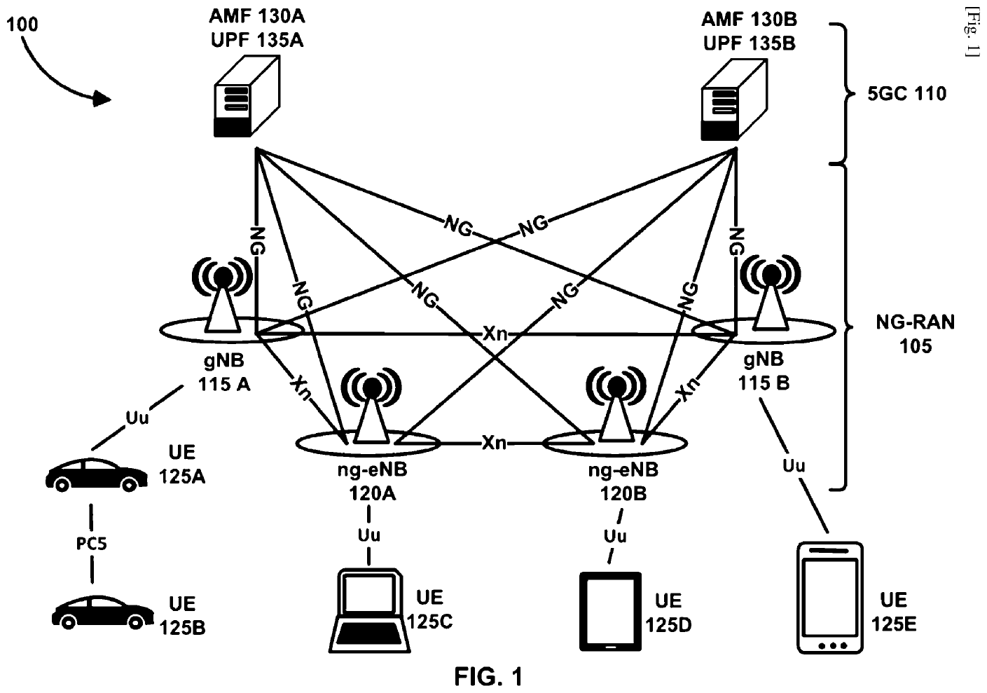

FIG. 1 shows an example of a system of mobile communications 100 according to some aspects of one or more exemplary embodiments of the present disclosure. The system of mobile communication 100 may be operated by a wireless communications system operator such as a Mobile Network Operator (MNO), a private network operator, a Multiple System Operator (MSO), an Internet of Things (JOT) network operator, etc., and may offer services such as voice, data (e.g., wireless Internet access), messaging, vehicular communications services such as Vehicle to Everything (V2X) communications services, safety services, mission critical service, services in residential, commercial or industrial settings such as IoT, industrial JOT (HOT), etc.

The system of mobile communications 100 may enable various types of applications with different requirements in terms of latency, reliability, throughput, etc. Example supported applications include enhanced Mobile Broadband (eMBB), Ultra-Reliable Low-Latency Communications (URLLC), and massive Machine Type Communications (mMTC). eMBB may support stable connections with high peak data rates, as well as moderate rates for cell-edge users. URLLC may support application with strict requirements in terms of latency and reliability and moderate requirements in terms of data rate. Example mMTC application includes a network of a massive number of IoT devices, which are only sporadically active and send small data payloads.

The system of mobile communications 100 may include a Radio Access Network (RAN) portion and a core network portion. The example shown in FIG. 1 illustrates a Next Generation RAN (NG-RAN) 105 and a 5G Core Network (5g-CN) 110 as examples of the RAN and core network, respectively. Other examples of RAN and core network may be implemented without departing from the scope of this disclosure. Other examples of RAN include Evolved Universal Terrestrial Radio Access Network (EUTRAN), Universal Terrestrial Radio Access Network (UTRAN), etc. Other examples of core network include Evolved Packet Core (EPC), UMTS Core Network (UCN), etc. The RAN implements a Radio Access Technology (RAT) and resides between User Equipments (UEs) 125 and the core network. Examples of such RATs include New Radio (NR), Long Term Evolution (LTE) also known as Evolved Universal Terrestrial Radio Access (EUTRA), Universal Mobile Telecommunication System (UMTS), etc. The RAT of the example system of mobile communications 100 may be NR. The core network resides between the RAN and one or more external networks (e.g., data networks) and is responsible for functions such as mobility management, authentication, session management, setting up bearers and application of different Quality of Services (QoSs). The functional layer between the UE 125 and the RAN (e.g., the NG-RAN 105) may be referred to as Access Stratum (AS) and the functional layer between the UE 125 and the core network (e.g., the 5G-CN 110) may be referred to as Non-access Stratum (NAS).

The UEs 125 may include wireless transmission and reception means for communications with one or more nodes in the RAN, one or more relay nodes, or one or more other UEs, etc. Example of UEs include, but are not limited to, smartphones, tablets, laptops, computers, wireless transmission and/or reception units in a vehicle, V2X or Vehicle to Vehicle (V2V) devices, wireless sensors, IoT devices, IIOT devices, etc. Other names may be used for UEs such as a Mobile Station (MS), terminal equipment, terminal node, client device, mobile device, etc. Still further, UEs 125 may also include components or subcomponents integrated into other devices, such as vehicles, to provide wireless communication functionality with nodes in the RAN as described herein. Such other devices may have other functionality or multiple functionalities in addition to wireless communications.

The RAN may include nodes (e.g., base stations) for communications with the UEs. For example, the NG-RAN 105 of the system of mobile communications 100 may comprise nodes for communications with the UEs 125. Different name for the RAN nodes may be used, for example depending on the RAT used for the RAN. A RAN node may be referred to as Node B (NB) in a RAN that used the UMTS RAT. A RAN node may be referred to as an evolved Node B (eNB) in a RAN that uses LTE/EUTRA RAT. For the illustrative example of the system of mobile communications 100 in FIG. 1, the nodes of an NG-RAN 105 may be either a next generation Node B (gNB) 115 or a next generation evolved Node B (ng-eNB) 120. In this specification, the terms base station, RAN node, gNB and ng-eNB may be used interchangeably. Illustratively, a communication network may be characterized as a set of geographic areas, referred to as cells, which may be logically organized in a contingent manner. The cells are organized in a manner such that individual cells may be associated with one or more base stations that establish wireless communications with a plurality of UEs. The base stations may be physically located within an individual cell such that wireless radio signals transmitted from the cell may be received by UEs also physically within the cell. In other embodiments, base stations may be located outside of the physical cell may be configured to transmit wireless signals to UEs within the cell. In some embodiments, individual UEs may be able to receive signals transmitted between adjacent cells due to overlapping signal coverage. In accordance, reference to communications from a target cell or existing cell can refer to connections between one or more base stations attributed to the cell and a UE 125.

The gNB 115 may provide NR user plane and control plane protocol terminations towards the UE 125. The ng-eNB 120 may provide E-UTRA user plane and control plane protocol terminations towards the UE 125. An interface between the gNB 115 and the UE 125 or between the ng-eNB 120 and the UE 125 may be referred to as a Uu interface. The Uu interface may be established with a user plane protocol stack and a control plane protocol stack. For a Uu interface, the direction from the base station (e.g., the gNB 115 or the ng-eNB 120) to the UE 125 may be referred to as downlink and the direction from the UE 125 to the base station (e.g., gNB 115 or ng-eNB 120) may be referred to as uplink.

The gNBs 115 and ng-eNBs 120 may be interconnected with each other by means of an Xn interface. The Xn interface may comprise an Xn User plane (Xn-U) interface and an Xn Control plane (Xn-C) interface. The transport network layer of the Xn-U interface may be built on Internet Protocol (IP) transport and GPRS Tunneling Protocol (GTP) may be used on top of User Datagram Protocol (UDP)/IP to carry the user plane protocol data units (PDUs). Xn-U may provide non-guaranteed delivery of user plane PDUs and may support data forwarding and flow control. The transport network layer of the Xn-C interface may be built on Stream Control Transport Protocol (SCTP) on top of IP. The application layer signaling protocol may be referred to as XnAP (Xn Application Protocol). The SCTP layer may provide the guaranteed delivery of application layer messages. In the transport IP layer, point-to-point transmission may be used to deliver the signaling PDUs. The Xn-C interface may support Xn interface management, UE mobility management, including context transfer and RAN paging, and dual connectivity.

The gNBs 115 and ng-eNBs 120 may also be connected to the 5GC 110 by means of the NG interfaces, more specifically to an Access and Mobility Management Function (AMF) 130 of the 5GC 110 by means of the NG-C interface and to a User Plane Function (UPF) 135 of the 5GC 110 by means of the NG-U interface. The transport network layer of the NG-U interface may be built on IP transport and GTP protocol may be used on top of UDP/IP to carry the user plane PDUs between the NG-RAN node (e.g., gNB 115 or ng-eNB 120) and the UPF 135. NG-U may provide non-guaranteed delivery of user plane PDUs between the NG-RAN node and the UPF. The transport network layer of the NG-C interface may be built on IP transport. For the reliable transport of signaling messages, SCTP may be added on top of IP. The application layer signaling protocol may be referred to as NGAP (NG Application Protocol). The SCTP layer may provide guaranteed delivery of application layer messages. In the transport, IP layer point-to-point transmission may be used to deliver the signaling PDUs. The NG-C interface may provide the following functions: NG interface management; UE context management; UE mobility management; transport of NAS messages; paging; PDU Session Management; configuration transfer; and warning message transmission.

The gNB 115 or the ng-eNB 120 may host one or more of the following functions: Radio Resource Management functions such as Radio Bearer Control, Radio Admission Control, Connection Mobility Control, Dynamic allocation of resources to UEs in both uplink and downlink (e.g., scheduling); IP and Ethernet header compression, encryption and integrity protection of data; Selection of an AMF at UE attachment when no routing to an AMF can be determined from the information provided by the UE; Routing of User Plane data towards UPF(s); Routing of Control Plane information towards AMF; Connection setup and release; Scheduling and transmission of paging messages; Scheduling and transmission of system broadcast information (e.g., originated from the AMF); Measurement and measurement reporting configuration for mobility and scheduling; Transport level packet marking in the uplink; Session Management; Support of Network Slicing; QoS Flow management and mapping to data radio bearers; Support of UEs in RRC Inactive state; Distribution function for NAS messages; Radio access network sharing; Dual Connectivity; Tight interworking between NR and E-UTRA; and Maintaining security and radio configuration for User Plane 5G system (5GS) Cellular IoT (CIoT) Optimization.

The AMF 130 may host one or more of the following functions: NAS signaling termination; NAS signaling security; AS Security control; Inter CN node signaling for mobility between 3GPP access networks; Idle mode UE Reachability (including control and execution of paging retransmission); Registration Area management; Support of intra-system and inter-system mobility; Access Authentication; Access Authorization including check of roaming rights; Mobility management control (subscription and policies); Support of Network Slicing; Session Management Function (SMF) selection; Selection of 5GS CIoT optimizations.

The UPF 135 may host one or more of the following functions: Anchor point for Intra-/Inter-RAT mobility (when applicable); External PDU session point of interconnect to Data Network; Packet routing & forwarding; Packet inspection and User plane part of Policy rule enforcement; Traffic usage reporting; Uplink classifier to support routing traffic flows to a data network; Branching point to support multihomed PDU session; QoS handling for user plane, e.g. packet filtering, gating, UL/DL rate enforcement; Uplink Traffic verification (Service Data Flow (SDF) to QoS flow mapping); Downlink packet buffering and downlink data notification triggering.

As shown in FIG. 1, the NG-RAN 105 may support the PC5 interface between two UEs 125 (e.g., UE 125A and UE125B). In the PC5 interface, the direction of communications between two UEs (e.g., from UE 125A to UE 125B or vice versa) may be referred to as sidelink. Sidelink transmission and reception over the PC5 interface may be supported when the UE 125 is inside NG-RAN 105 coverage, irrespective of which RRC state the UE is in, and when the UE 125 is outside NG-RAN 105 coverage. Support of V2X services via the PC5 interface may be provided by NR sidelink communication and/or V2X sidelink communication.

PC5-S signaling may be used for unicast link establishment with Direct Communication Request/Accept message. A UE may self-assign its source Layer-2 ID for the PC5 unicast link for example based on the V2X service type. During unicast link establishment procedure, the UE may send its source Layer-2 ID for the PC5 unicast link to the peer UE, e.g., the UE for which a destination ID has been received from the upper layers. A pair of source Layer-2 ID and destination Layer-2 ID may uniquely identify a unicast link. The receiving UE may verify that the said destination ID belongs to it and may accept the Unicast link establishment request from the source UE. During the PC5 unicast link establishment procedure, a PC5-RRC procedure on the Access Stratum may be invoked for the purpose of UE sidelink context establishment as well as for AS layer configurations, capability exchange etc. PC5-RRC signaling may enable exchanging UE capabilities and AS layer configurations such as Sidelink Radio Bearer configurations between pair of UEs for which a PC5 unicast link is established.

NR sidelink communication may support one of three types of transmission modes (e.g., Unicast transmission, Groupcast transmission, and Broadcast transmission) for a pair of a Source Layer-2 ID and a Destination Layer-2 ID in the AS. The Unicast transmission mode may be characterized by: Support of one PC5-RRC connection between peer UEs for the pair; Transmission and reception of control information and user traffic between peer UEs in sidelink; Support of sidelink HARQ feedback; Support of sidelink transmit power control; Support of RLC Acknowledged Mode (AM); and Detection of radio link failure for the PC5-RRC connection. The Groupcast transmission may be characterized by: Transmission and reception of user traffic among UEs belonging to a group in sidelink; and Support of sidelink HARQ feedback. The Broadcast transmission may be characterized by: Transmission and reception of user traffic among UEs in sidelink.

A Source Layer-2 ID, a Destination Layer-2 ID and a PC5 Link Identifier may be used for NR sidelink communication. The Source Layer-2 ID may identify the sender of the data in NR sidelink communication. The Source Layer-2 ID may be 24 bits long and may be split in the MAC layer into two-bit strings: One bit string may be the LSB part (8 bits) of Source Layer-2 ID and forwarded to physical layer of the sender. This may identify the source of the intended data in sidelink control information and may be used for filtering of packets at the physical layer of the receiver; and the Second bit string may be the MSB part (16 bits) of the Source Layer-2 ID and may be carried within the Medium Access Control (MAC) header. This may be used for filtering of packets at the MAC layer of the receiver. The Destination Layer-2 ID may identify the target of the data in NR sidelink communication. For NR sidelink communication, the Destination Layer-2 ID may be 24 bits long and may be split in the MAC layer into two-bit strings: One-bit string may be the LSB part (16 bits) of Destination Layer-2 ID and forwarded to physical layer of the sender. This may identify the target of the intended data in sidelink control information and may be used for filtering of packets at the physical layer of the receiver; and the Second bit string may be the MSB part (8 bits) of the Destination Layer-2 ID and may be carried within the MAC header. This may be used for filtering of packets at the MAC layer of the receiver. The PC5 Link Identifier may uniquely identify the PC5 unicast link in a UE for the lifetime of the PC5 unicast link. The PC5 Link Identifier may be used to indicate the PC5 unicast link whose sidelink Radio Link failure (RLF) declaration was made and PC5-RRC connection was released.

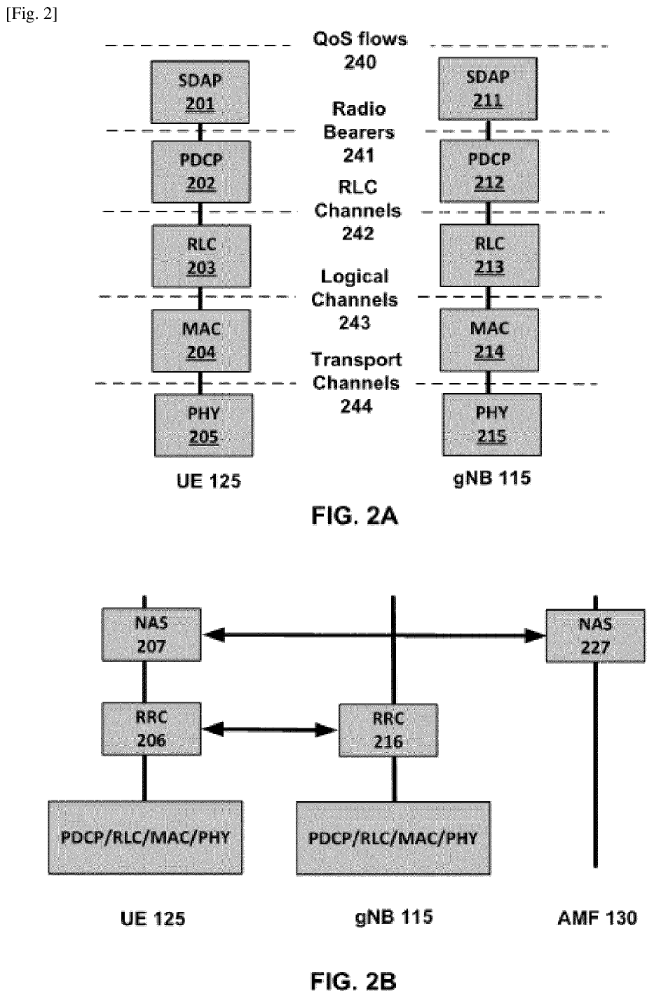

FIG. 2A and FIG. 2B show examples of radio protocol stacks for user plane and control plane, respectively, according to some aspects of one or more exemplary embodiments of the present disclosure. As shown in FIG. 2A, the protocol stack for the user plane of the Uu interface (between the UE 125 and the gNB 115) includes Service Data Adaptation Protocol (SDAP) 201 and SDAP 211, Packet Data Convergence Protocol (PDCP) 202 and PDCP 212, Radio Link Control (RLC) 203 and RLC 213, MAC 204 and MAC 214 sublayers of layer 2 and Physical (PHY) 205 and PHY 215 layer (layer 1 also referred to as L1).

The PHY 205 and PHY 215 offer transport channels 244 to the MAC 204 and MAC 214 sublayer. The MAC 204 and MAC 214 sublayer offer logical channels 243 to the RLC 203 and RLC 213 sublayer. The RLC 203 and RLC 213 sublayer offer RLC channels 242 to the PDCP 202 and PCP 212 sublayer. The PDCP 202 and PDCP 212 sublayer offer radio bearers 241 to the SDAP 201 and SDAP 211 sublayer. Radio bearers may be categorized into two groups: Data Radio Bearers (DRBs) for user plane data and Signaling Radio Bearers (SRBs) for control plane data. The SDAP 201 and SDAP 211 sublayer offers QoS flows 240 to 5GC.

The main services and functions of the MAC 204 or MAC 214 sublayer include: mapping between logical channels and transport channels; Multiplexing/demultiplexing of MAC Service Data Units (SDUs) belonging to one or different logical channels into/from Transport Blocks (TB) delivered to/from the physical layer on transport channels; Scheduling information reporting; Error correction through Hybrid Automatic Repeat Request (HARQ) (one HARQ entity per cell in case of carrier aggregation (CA)); Priority handling between UEs by means of dynamic scheduling; Priority handling between logical channels of one UE by means of Logical Channel Prioritization (LCP); Priority handling between overlapping resources of one UE; and Padding. A single MAC entity may support multiple numerologies, transmission timings and cells. Mapping restrictions in logical channel prioritization control which numerology(ies), cell(s), and transmission timing(s) a logical channel may use.

The HARQ functionality may ensure delivery between peer entities at Layer 1. A single HARQ process may support one TB when the physical layer is not configured for downlink/uplink spatial multiplexing, and when the physical layer is configured for downlink/uplink spatial multiplexing, a single HARQ process may support one or multiple TBs.

The RLC 203 or RLC 213 sublayer may support three transmission modes: Transparent Mode (TM); Unacknowledged Mode (UM); and Acknowledged Mode (AM). The RLC configuration may be per logical channel with no dependency on numerologies and/or transmission durations, and Automatic Repeat Request (ARQ) may operate on any of the numerologies and/or transmission durations the logical channel is configured with.

The main services and functions of the RLC 203 or RLC 213 sublayer depend on the transmission mode (e.g., TM, UM or AM) and may include: Transfer of upper layer PDUs; Sequence numbering independent of the one in PDCP (UM and AM); Error Correction through ARQ (AM only); Segmentation (AM and UM) and resegmentation (AM only) of RLC SDUs; Reassembly of SDU (AM and UM); Duplicate Detection (AM only); RLC SDU discard (AM and UM); RLC re-establishment; and Protocol error detection (AM only).

The automatic repeat request within the RLC 203 or RLC 213 sublayer may have the following characteristics: ARQ retransmits RLC SDUs or RLC SDU segments based on RLC status reports; Polling for RLC status report may be used when needed by RLC; RLC receiver may also trigger RLC status report after detecting a missing RLC SDU or RLC SDU segment.

The main services and functions of the PDCP 202 or PDCP 212 sublayer may include: Transfer of data (user plane or control plane); Maintenance of PDCP Sequence Numbers (SNs); Header compression and decompression using the Robust Header Compression (ROHC) protocol; Header compression and decompression using EHC protocol; Ciphering and deciphering; Integrity protection and integrity verification; Timer based SDU discard; Routing for split bearers; Duplication; Reordering and in-order delivery; Out-of-order delivery; and Duplicate discarding.

The main services and functions of SDAP 201 or SDAP 211 include: Mapping between a QoS flow and a data radio bearer; and Marking QoS Flow ID (QFI) in both downlink and uplink packets. A single protocol entity of SDAP may be configured for each individual PDU session.

As shown in FIG. 2B, the protocol stack of the control plane of the Uu interface (between the UE 125 and the gNB 115) includes PHY layer (layer 1), and MAC, RLC and PDCP sublayers of layer 2 as described above and in addition, the RRC 206 sublayer and RRC 216 sublayer. The main services and functions of the RRC 206 sublayer and the RRC 216 sublayer over the Uu interface include: Broadcast of System Information related to AS and NAS; Paging initiated by 5GC or NG-RAN; Establishment, maintenance and release of an RRC connection between the UE and NG-RAN (including Addition, modification and release of carrier aggregation; and Addition, modification and release of Dual Connectivity in NR or between E-UTRA and NR); Security functions including key management; Establishment, configuration, maintenance and release of SRBs and DRBs; Mobility functions (including Handover and context transfer; UE cell selection and reselection and control of cell selection and reselection; and Inter-RAT mobility); QoS management functions; UE measurement reporting and control of the reporting; Detection of and recovery from radio link failure; and NAS message transfer to/from NAS from/to UE. The NAS 207 and NAS 227 layer is a control protocol (terminated in AMF on the network side) that performs the functions such as authentication, mobility management, security control, etc.

The sidelink specific services and functions of the RRC sublayer over the Uu interface include: Configuration of sidelink resource allocation via system information or dedicated signaling; Reporting of UE sidelink information; Measurement configuration and reporting related to sidelink; and Reporting of UE assistance information for SL traffic pattern(s).

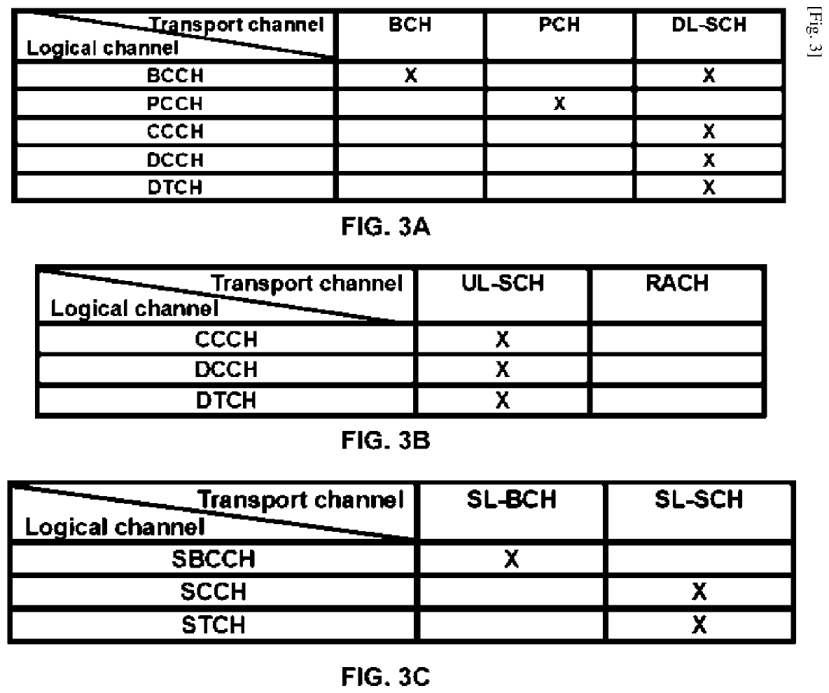

FIG. 3A, FIG. 3B and FIG. 3C show example mappings between logical channels and transport channels in downlink, uplink and sidelink, respectively, according to some aspects of one or more exemplary embodiments of the present disclosure. Different kinds of data transfer services may be offered by MAC. Each logical channel type may be defined by what type of information is transferred. Logical channels may be classified into two groups: Control Channels and Traffic Channels. Control channels may be used for the transfer of control plane information only. The Broadcast Control Channel (BCCH) is a downlink channel for broadcasting system control information. The Paging Control Channel (PCCH) is a downlink channel that carries paging messages. The Common Control Channel (CCCH) is channel for transmitting control information between UEs and network. This channel may be used for UEs having no RRC connection with the network. The Dedicated Control Channel (DCCH) is a point-to-point bi-directional channel that transmits dedicated control information between a UE and the network and may be used by UEs having an RRC connection. Traffic channels may be used for the transfer of user plane information only. The Dedicated Traffic Channel (DTCH) is a point-to-point channel, dedicated to one UE, for the transfer of user information. A DTCH may exist in both uplink and downlink. Sidelink Control Channel (SCCH) is a sidelink channel for transmitting control information (e.g., PC5-RRC and PC5-S messages) from one UE to other UE(s). Sidelink Traffic Channel (STCH) is a sidelink channel for transmitting user information from one UE to other UE(s). Sidelink Broadcast Control Channel (SBCCH) is a sidelink channel for broadcasting sidelink system information from one UE to other UE(s).

The downlink transport channel types include Broadcast Channel (BCH), Downlink Shared Channel (DL-SCH), and Paging Channel (PCH). The BCH may be characterized by: fixed, pre-defined transport format; and requirement to be broadcast in the entire coverage area of the cell, either as a single message or by beamforming different BCH instances. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; and the support for UE Discontinuous Reception (DRX) to enable UE power saving. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; support for UE discontinuous reception (DRX) to enable UE power saving. The PCH may be characterized by: support for UE discontinuous reception (DRX) to enable UE power saving (DRX cycle is indicated by the network to the UE); requirement to be broadcast in the entire coverage area of the cell, either as a single message or by beamforming different BCH instances; mapped to physical resources which can be used dynamically also for traffic/other control channels.

In downlink, the following connections between logical channels and transport channels may exist: BCCH may be mapped to BCH; BCCH may be mapped to DLSCH; PCCH may be mapped to PCH; CCCH may be mapped to DL-SCH; DCCH may be mapped to DL-SCH; and DTCH may be mapped to DL-SCH.

The uplink transport channel types include Uplink Shared Channel (UL-SCH) and Random Access Channel(s) (RACH). The UL-SCH may be characterized by possibility to use beamforming; support for dynamic link adaptation by varying the transmit power and potentially modulation and coding; support for HARQ; support for both dynamic and semi-static resource allocation. The RACH may be characterized by limited control information; and collision risk.

In Uplink, the following connections between logical channels and transport channels may exist: CCCH may be mapped to UL-SCH; DCCH may be mapped to UL-SCH; and DTCH may be mapped to UL-SCH.

The sidelink transport channel types include: Sidelink broadcast channel (SL-BCH) and Sidelink shared channel (SL-SCH). The SL-BCH may be characterized by predefined transport format. The SL-SCH may be characterized by support for unicast transmission, groupcast transmission and broadcast transmission; support for both UE autonomous resource selection and scheduled resource allocation by NG-RAN; support for both dynamic and semi-static resource allocation when UE is allocated resources by the NG-RAN; support for HARQ; and support for dynamic link adaptation by varying the transmit power, modulation and coding.

In the sidelink, the following connections between logical channels and transport channels may exist: SCCH may be mapped to SL-SCH; STCH may be mapped to SLSCH; and SBCCH may be mapped to SL-BCH.

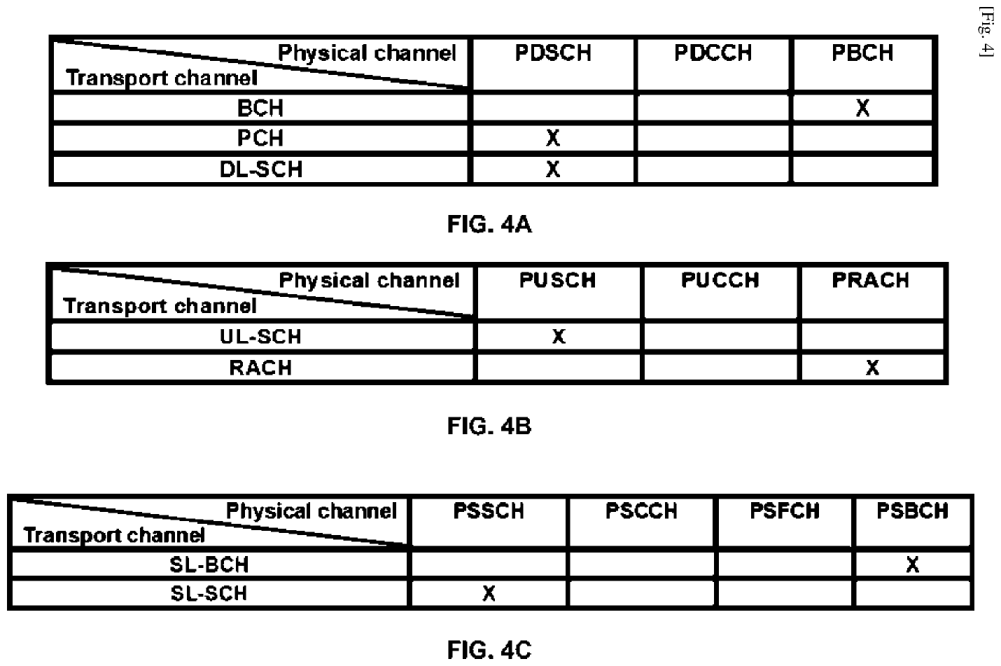

FIG. 4A, FIG. 4B and FIG. 4C show example mappings between transport channels and physical channels in downlink, uplink and sidelink, respectively, according to some aspects of one or more exemplary embodiments of the present disclosure. The physical channels in downlink include Physical Downlink Shared Channel (PDSCH), Physical Downlink Control Channel (PDCCH) and Physical Broadcast Channel (PBCH). The PCH and DL-SCH transport channels are mapped to the PDSCH. The BCH transport channel is mapped to the PBCH. A transport channel is not mapped to the PDCCH but Downlink Control Information (DCI) is transmitted via the PDCCH.

The physical channels in the uplink include Physical Uplink Shared Channel (PUSCH), Physical Uplink Control Channel (PUCCH) and Physical Random Access Channel (PRACH). The UL-SCH transport channel may be mapped to the PUSCH and the RACH transport channel may be mapped to the PRACH. A transport channel is not mapped to the PUCCH but Uplink Control Information (UCI) is transmitted via the PUCCH.

The physical channels in the sidelink include Physical Sidelink Shared Channel (PSSCH), Physical Sidelink Control Channel (PSCCH), Physical Sidelink Feedback Channel (PSFCH) and Physical Sidelink Broadcast Channel (PSBCH). The Physical Sidelink Control Channel (PSCCH) may indicate resource and other transmission parameters used by a UE for PSSCH. The Physical Sidelink Shared Channel (PSSCH) may transmit the TBs of data themselves, and control information for HARQ procedures and CSI feedback triggers, etc. At least 6 OFDM symbols within a slot may be used for PSSCH transmission. Physical Sidelink Feedback Channel (PSFCH) may carry the HARQ feedback over the sidelink from a UE which is an intended recipient of a PSSCH transmission to the UE which performed the transmission. PSFCH sequence may be transmitted in one PRB repeated over two OFDM symbols near the end of the sidelink resource in a slot. The SL-SCH transport channel may be mapped to the PSSCH. The SL-BCH may be mapped to PSBCH. No transport channel is mapped to the PSFCH but Sidelink Feedback Control Information (SFCI) may be mapped to the PSFCH. No transport channel is mapped to PSCCH but Sidelink Control Information (SCI) may be mapped to the PSCCH.

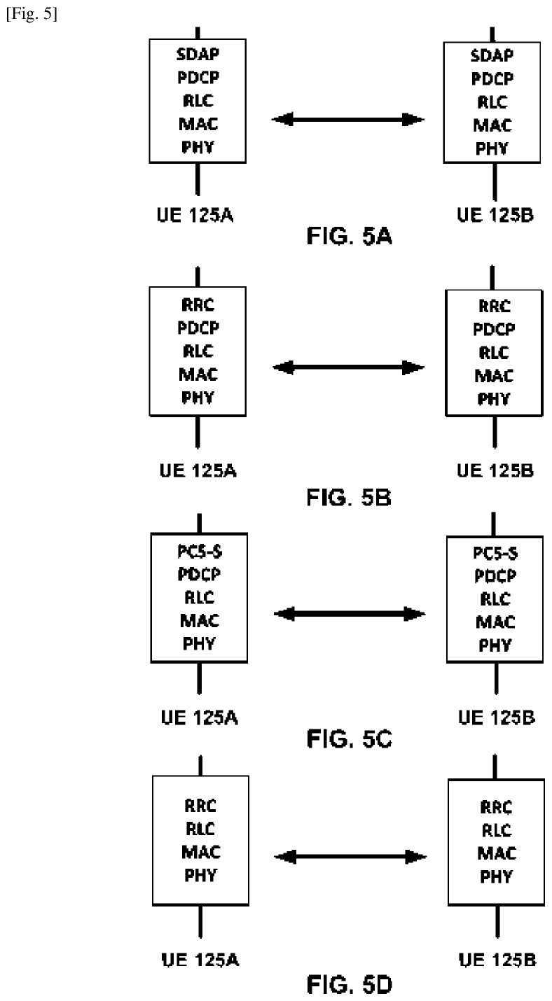

FIG. 5A, FIG. 5B, FIG. 5C and FIG. 5D show examples of radio protocol stacks for NR sidelink communication according to some aspects of one or more exemplary embodiments of the present disclosure. The AS protocol stack for user plane in the PC5 interface (i.e., for STCH) may consist of SDAP, PDCP, RLC and MAC sublayers, and the physical layer. The protocol stack of user plane is shown in FIG. 5A. The AS protocol stack for SBCCH in the PC5 interface may consist of RRC, RLC, MAC sublayers, and the physical layer as shown below in FIG. 5B. For support of PC5-S protocol, PC5-S is located on top of PDCP, RLC and MAC sublayers, and the physical layer in the control plane protocol stack for SCCH for PC5-S, as shown in FIG. 5C. The AS protocol stack for the control plane for SCCH for RRC in the PC5 interface consists of RRC, PDCP, RLC and MAC sublayers, and the physical layer. The protocol stack of control plane for SCCH for RRC is shown in FIG. 5D.

The Sidelink Radio Bearers (SLRBs) may be categorized into two groups: Sidelink Data Radio Bearers (SL DRB) for user plane data and Sidelink Signaling Radio Bearers (SL SRB) for control plane data. Separate SL SRBs using different SCCHs may be configured for PC5-RRC and PC5-S signaling, respectively.

The MAC sublayer may provide the following services and functions over the PC5 interface: Radio resource selection; Packet filtering; Priority handling between uplink and sidelink transmissions for a given UE; and Sidelink CSI reporting. With logical channel prioritization restrictions in MAC, only sidelink logical channels belonging to the same destination may be multiplexed into a MAC PDU for every unicast, groupcast and broadcast transmission which may be associated to the destination. For packet filtering, a SL-SCH MAC header including portions of both Source Layer-2 ID and a Destination Layer-2 ID may be added to a MAC PDU. The Logical Channel Identifier (LCID) included within a MAC subheader may uniquely identify a logical channel within the scope of the Source Layer-2 ID and Destination Layer-2 ID combination.

The services and functions of the RLC sublayer may be supported for sidelink. Both RLC Unacknowledged Mode (UM) and Acknowledged Mode (AM) may be used in unicast transmission while only UM may be used in groupcast or broadcast transmission. For UM, only unidirectional transmission may be supported for groupcast and broadcast.

The services and functions of the PDCP sublayer for the Uu interface may be supported for sidelink with some restrictions: Out-of-order delivery may be supported only for unicast transmission; and Duplication may not be supported over the PC5 interface.

The SDAP sublayer may provide the following service and function over the PC5 interface: Mapping between a QoS flow and a sidelink data radio bearer. There may be one SDAP entity per destination for one of unicast, groupcast and broadcast which is associated to the destination.

The RRC sublayer may provide the following services and functions over the PC5 interface: Transfer of a PC5-RRC message between peer UEs; Maintenance and release of a PC5-RRC connection between two UEs; and Detection of sidelink radio link failure for a PC5-RRC connection based on indication from MAC or RLC. A PC5-RRC connection may be a logical connection between two UEs for a pair of Source and Destination Layer-2 IDs which may be considered to be established after a corresponding PC5 unicast link is established. There may be one-to-one correspondence between the PC5-RRC connection and the PC5 unicast link. A UE may have multiple PC5-RRC connections with one or more UEs for different pairs of Source and Destination Layer-2 IDs. Separate PC5-RRC procedures and messages may be used for a UE to transfer UE capability and sidelink configuration including SL-DRB configuration to the peer UE. Both peer UEs may exchange their own UE capability and sidelink configuration using separate bi-directional procedures in both sidelink directions.

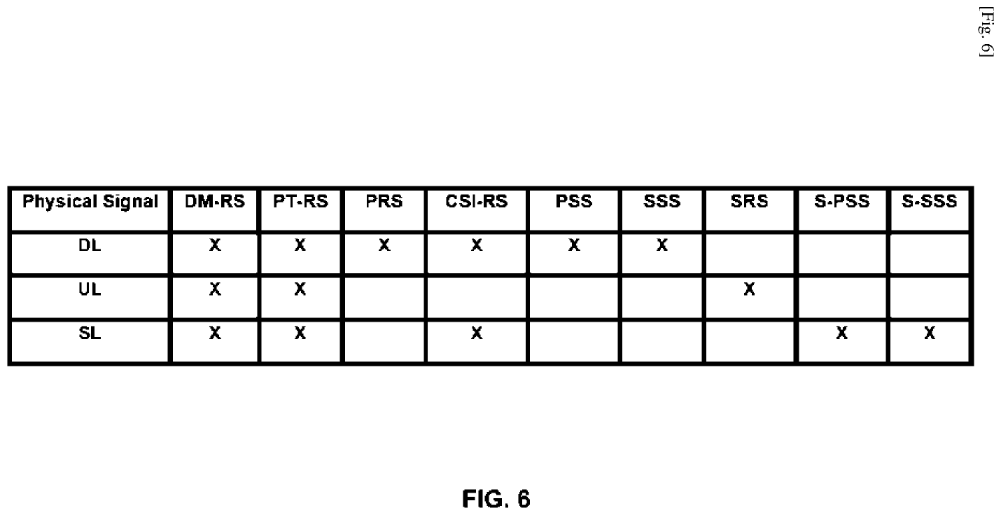

FIG. 6 shows example physical signals in downlink, uplink and sidelink according to some aspects of one or more exemplary embodiments of the present disclosure. The Demodulation Reference Signal (DM-RS) may be used in downlink, uplink and sidelink and may be used for channel estimation. DM-RS is a UE-specific reference signal and may be transmitted together with a physical channel in downlink, uplink or sidelink and may be used for channel estimation and coherent detection of the physical channel. The Phase Tracking Reference Signal (PT-RS) may be used in downlink, uplink and sidelink and may be used for tracking the phase and mitigating the performance loss due to phase noise. The PT-RS may be used mainly to estimate and minimize the effect of Common Phase Error (CPE) on system performance. Due to the phase noise properties, PT-RS signal may have a low density in the frequency domain and a high density in the time domain. PT-RS may occur in combination with DM-RS and when the network has configured PT-RS to be present. The Positioning Reference Signal (PRS) may be used in downlink for positioning using different positioning techniques. PRS may be used to measure the delays of the downlink transmissions by correlating the received signal from the base station with a local replica in the receiver. The Channel State Information Reference Signal (CSI-RS) may be used in downlink and sidelink. CSI-RS may be used for channel state estimation, Reference Signal Received Power (RSRP) measurement for mobility and beam management, time/frequency tracking for demodulation among other uses. CSI-RS may be configured UE-specifically but multiple users may share the same CSI-RS resource. The UE may determine CSI reports and transit them in the uplink to the base station using PUCCH or PUSCH. The CSI report may be carried in a sidelink MAC CE. The Primary Synchronization Signal (PSS) and the Secondary Synchronization Signal (SSS) may be used for radio fame synchronization. The PSS and SSS may be used for the cell search procedure during the initial attach or for mobility purposes. The Sounding Reference Signal (SRS) may be used in uplink for uplink channel estimation. Similar to CSI-RS, the SRS may serve as QCL reference for other physical channels such that they can be configured and transmitted quasi-collocated with SRS. The Sidelink PSS (S-PSS) and Sidelink SSS (S-SSS) may be used in sidelink for sidelink synchronization.

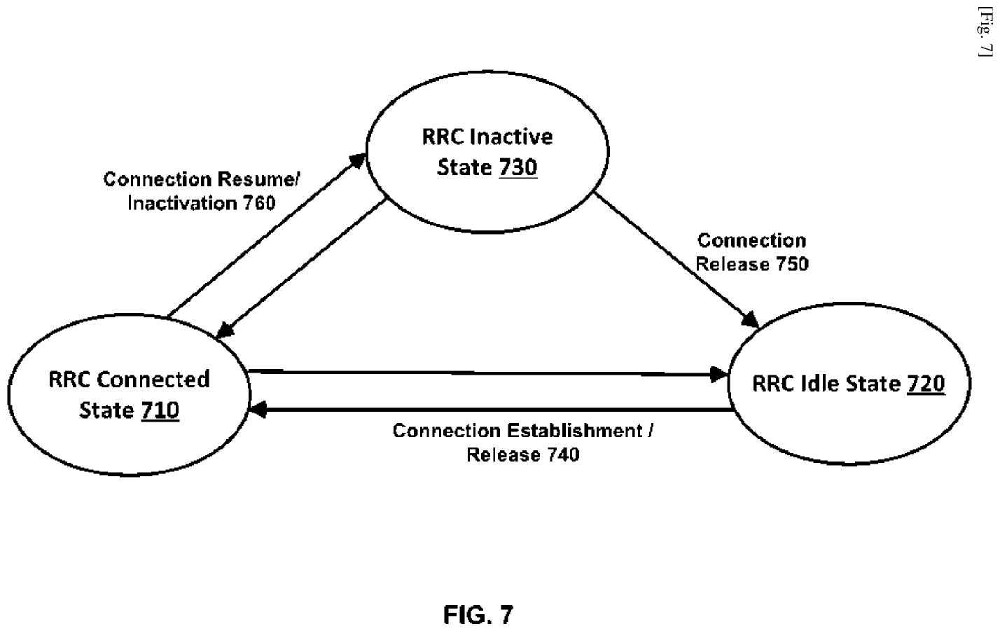

FIG. 7 shows examples of Radio Resource Control (RRC) states and transitioning between different RRC states according to some aspects of one or more exemplary embodiments of the present disclosure. A UE may be in one of three RRC states: RRC Connected State 710, RRC Idle State 720 and RRC Inactive state 730. After power up, the UE may be in RRC Idle state 720 and the UE may establish connection with the network using initial access and via an RRC connection establishment procedure to perform data transfer and/or to make/receive voice calls. Once RRC connection is established, the UE may be in RRC Connected State 710. The UE may transition from the RRC Idle state 720 to the RRC connected state 710 or from the RRC Connected State 710 to the RRC Idle state 720 using the RRC connection Establishment/Release procedures 740.

To reduce the signaling load and the latency resulting from frequent transitioning from the RRC Connected State 710 to the RRC Idle State 720 when the UE transmits frequent small data, the RRC Inactive State 730 may be used. In the RRC Inactive State 730, the AS context may be stored by both UE and gNB. This may result in faster state transition from the RRC Inactive State 730 to RRC Connected State 710. The UE may transition from the RRC Inactive State 730 to the RRC Connected State 710 or from the RRC Connected State 710 to the RRC Inactive State 730 using the RRC Connection Resume/Inactivation procedures 760. The UE may transition from the RRC Inactive State 730 to RRC Idle State 720 using an RRC Connection Release procedure 750.

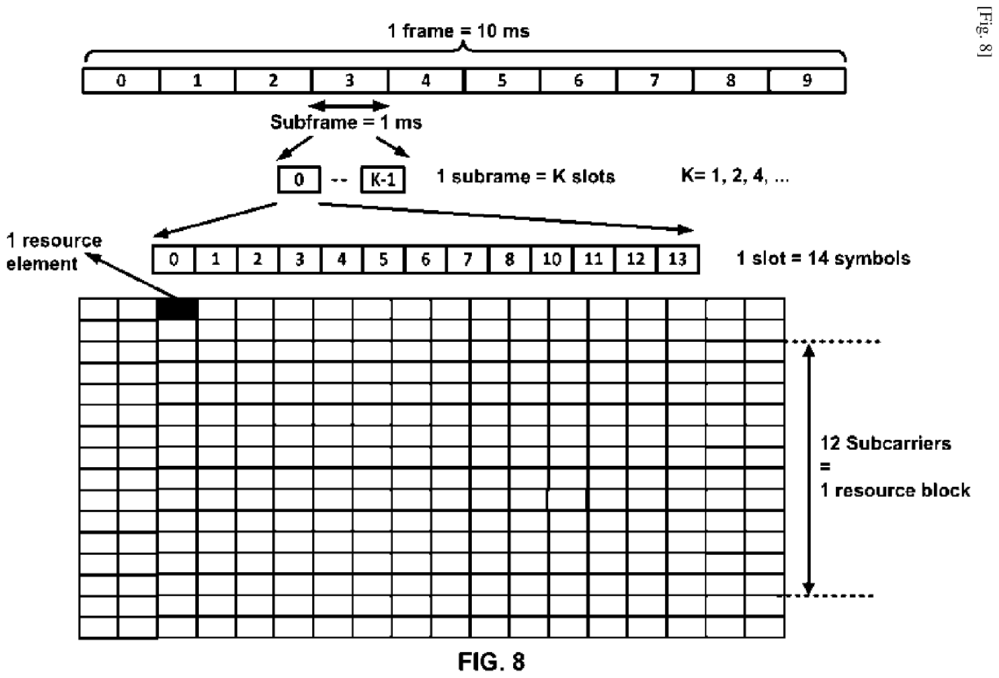

FIG. 8 shows example frame structure and physical resources according to some aspects of one or more exemplary embodiments of the present disclosure. The downlink or uplink or sidelink transmissions may be organized into frames with 10 ms duration, consisting of ten 1 ms subframes. Each subframe may consist of 1, 2, 4, . . . slots, wherein the number of slots per subframe may depend of the subcarrier spacing of the carrier on which the transmission takes place. The slot duration may be 14 symbols with Normal Cyclic Prefix (CP) and 12 symbols with Extended CP and may scale in time as a function of the used sub-carrier spacing so that there is an integer number of slots in a subframe. FIG. 8 shows a resource grid in time and frequency domain. Each element of the resource grid, comprising one symbol in time and one subcarrier in frequency, is referred to as a Resource Element (RE). A Resource Block (RB) may be defined as 12 consecutive subcarriers in the frequency domain.

In some examples and with non-slot-based scheduling, the transmission of a packet may occur over a portion of a slot, for example during 2, 4 or 7 OFDM symbols which may also be referred to as mini-slots. The mini-slots may be used for low latency applications such as URLLC and operation in unlicensed bands. In some embodiments, the mini-slots may also be used for fast flexible scheduling of services (e.g., preemption of URLLC over eMBB).

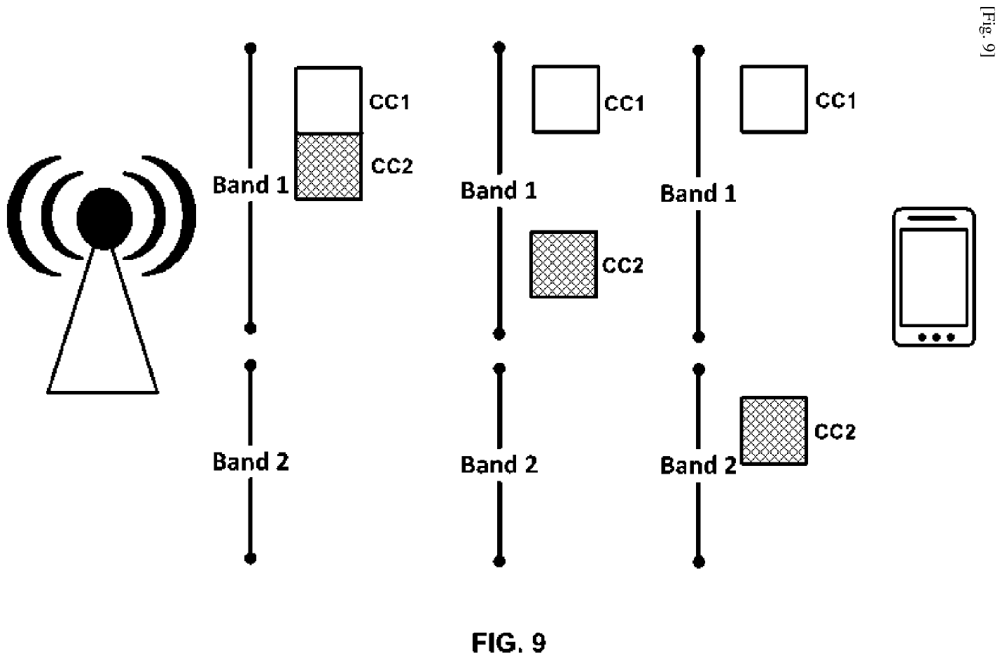

FIG. 9 shows example component carrier configurations in different carrier aggregation scenarios according to some aspects of one or more exemplary embodiments of the present disclosure. In Carrier Aggregation (CA), two or more Component Carriers (CCs) may be aggregated. A UE may simultaneously receive or transmit on one or multiple CCs depending on its capabilities. CA may be supported for both contiguous and non-contiguous CCs in the same band or on different bands as shown in FIG. 9. A gNB and the UE may communicate using a serving cell. A serving cell may be associated at least with one downlink CC (e.g., may be associated only with one downlink CC or may be associated with a downlink CC and an uplink CC). A serving cell may be a Primary Cell (PCell) or a Secondary cCell (SCell).

A UE may adjust the timing of its uplink transmissions using an uplink timing control procedure. A Timing Advance (TA) may be used to adjust the uplink frame timing relative to the downlink frame timing. The gNB may determine the desired Timing Advance setting and provides that to the UE. The UE may use the provided TA to determine its uplink transmit timing relative to the UE's observed downlink receive timing.

In the RRC Connected state, the gNB may be responsible for maintaining the timing advance to keep the L1 synchronized. Serving cells having uplink to which the same timing advance applies and using the same timing reference cell are grouped in a Timing Advance Group (TAG). A TAG may contain at least one serving cell with configured uplink. The mapping of a serving cell to a TAG may be configured by RRC. For the primary TAG, the UE may use the PCell as timing reference cell, except with shared spectrum channel access where an SCell may also be used as timing reference cell in certain cases. In a secondary TAG, the UE may use any of the activated SCells of this TAG as a timing reference cell and may not change it unless necessary.

Timing advance updates may be signaled by the gNB to the UE via MAC CE commands. Such commands may restart a TAG-specific timer which may indicate whether the L1 can be synchronized or not: when the timer is running, the L1 may be considered synchronized, otherwise, the L1 may be considered non-synchronized (in which case uplink transmission may only take place on PRACH).

A UE with single timing advance capability for CA may simultaneously receive and/or transmit on multiple CCs corresponding to multiple serving cells sharing the same timing advance (multiple serving cells grouped in one TAG). A UE with multiple timing advance capability for CA may simultaneously receive and/or transmit on multiple CCs corresponding to multiple serving cells with different timing advances (multiple serving cells grouped in multiple TAGs). The NG-RAN may ensure that each TAG contains at least one serving cell. A non-CA capable UE may receive on a single CC and may transmit on a single CC corresponding to one serving cell only (one serving cell in one TAG).

The multi-carrier nature of the physical layer in case of CA may be exposed to the MAC layer and one HARQ entity may be required per serving cell. When CA is configured, the UE may have one RRC connection with the network. At RRC connection establishment/re-establishment/handover, one serving cell (e.g., the PCell) may provide the NAS mobility information. Depending on UE capabilities, SCells may be configured to form together with the PCell a set of serving cells. The configured set of serving cells for a UE may consist of one PCell and one or more SCells. The reconfiguration, addition and removal of SCells may be performed by RRC.

In a dual connectivity scenario, a UE may be configured with a plurality of cells comprising a Master Cell Group (MCG) for communications with a master base station, a Secondary Cell Group (SCG) for communications with a secondary base station, and two MAC entities: one MAC entity and for the MCG for communications with the master base station and one MAC entity for the SCG for communications with the secondary base station.

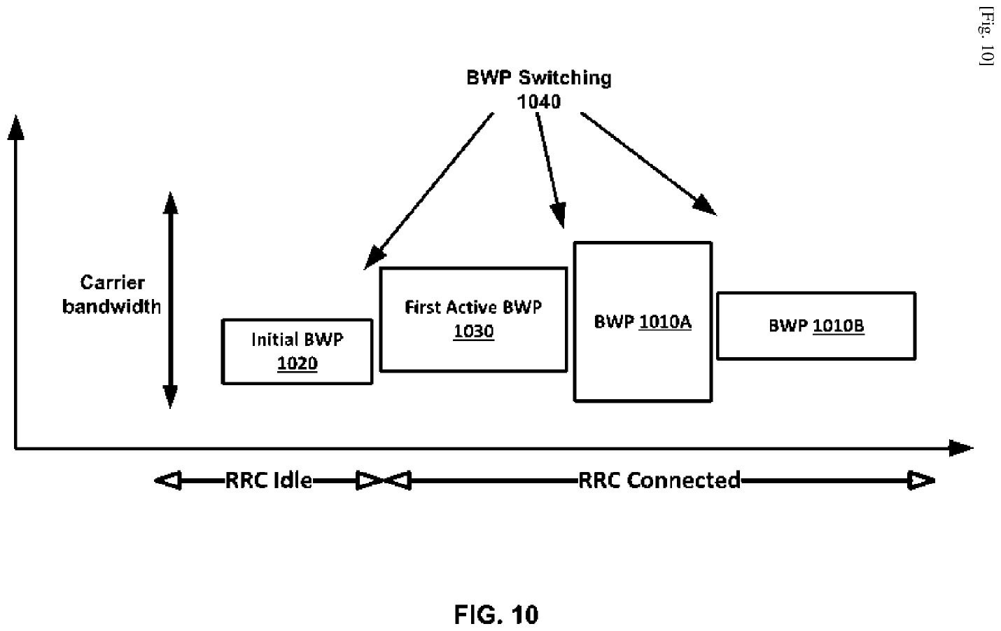

FIG. 10 shows example bandwidth part configuration and switching according to some aspects of one or more exemplary embodiments of the present disclosure. The UE may be configured with one or more Bandwidth Parts (BWPs) 1010 on a given component carrier. In some examples, one of the one or more bandwidth parts may be active at a time. The active bandwidth part may define the UE's operating bandwidth within the cell's operating bandwidth. For initial access, and until the UE's configuration in a cell is received, initial bandwidth part 1020 determined from system information may be used. With Bandwidth Adaptation (BA), for example through BWP switching 1040, the receive and transmit bandwidth of a UE may not be as large as the bandwidth of the cell and may be adjusted. For example, the width may be ordered to change (e.g. to shrink during period of low activity to save power); the location may move in the frequency domain (e.g. to increase scheduling flexibility); and the subcarrier spacing may be ordered to change (e.g. to allow different services). The first active BWP 1020 may be the active BWP upon RRC (re-)configuration for a PCell or activation of an SCell.

For a downlink BWP or uplink BWP in a set of downlink BWPs or uplink BWPs, respectively, the UE may be provided the following configuration parameters: a Subcarrier Spacing (SCS); a cyclic prefix; a common RB and a number of contiguous RBs; an index in the set of downlink BWPs or uplink BWPs by respective BWP-Id; a set of BWP-common and a set of BWP-dedicated parameters. A BWP may be associated with an OFDM numerology according to the configured subcarrier spacing and cyclic prefix for the BWP. For a serving cell, a UE may be provided by a default downlink BWP among the configured downlink BWPs. If a UE is not provided a default downlink BWP, the default downlink BWP may be the initial downlink BWP.

A downlink BWP may be associated with a BWP inactivity timer. If the BWP inactivity timer associated with the active downlink BWP expires and if the default downlink BWP is configured, the UE may perform BWP switching to the default BWP. If the BWP inactivity timer associated with the active downlink BWP expires and if the default downlink BWP is not configured, the UE may perform BWP switching to the initial downlink BWP.

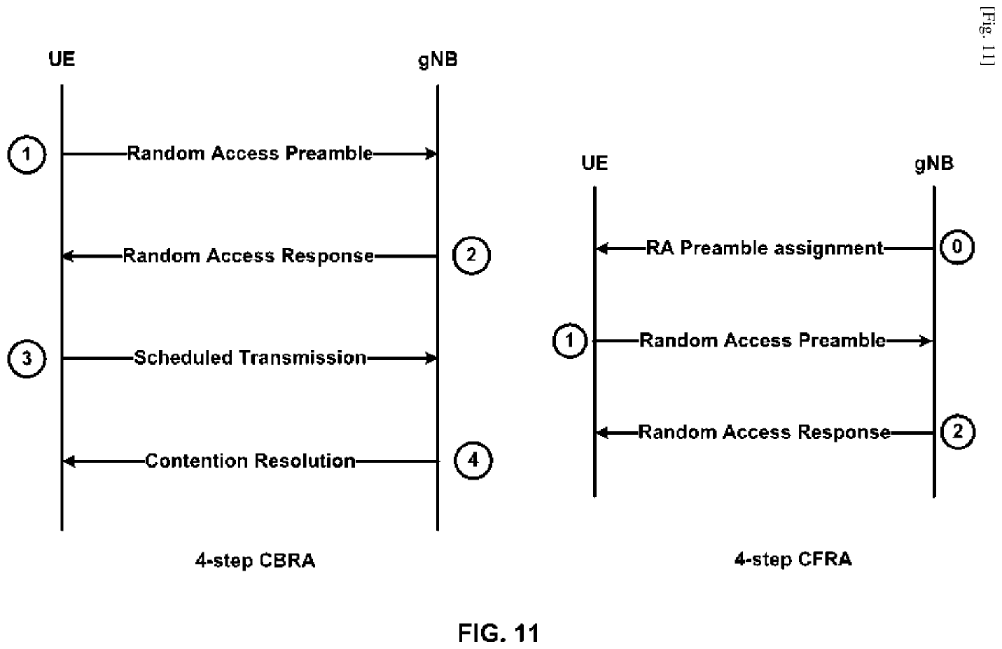

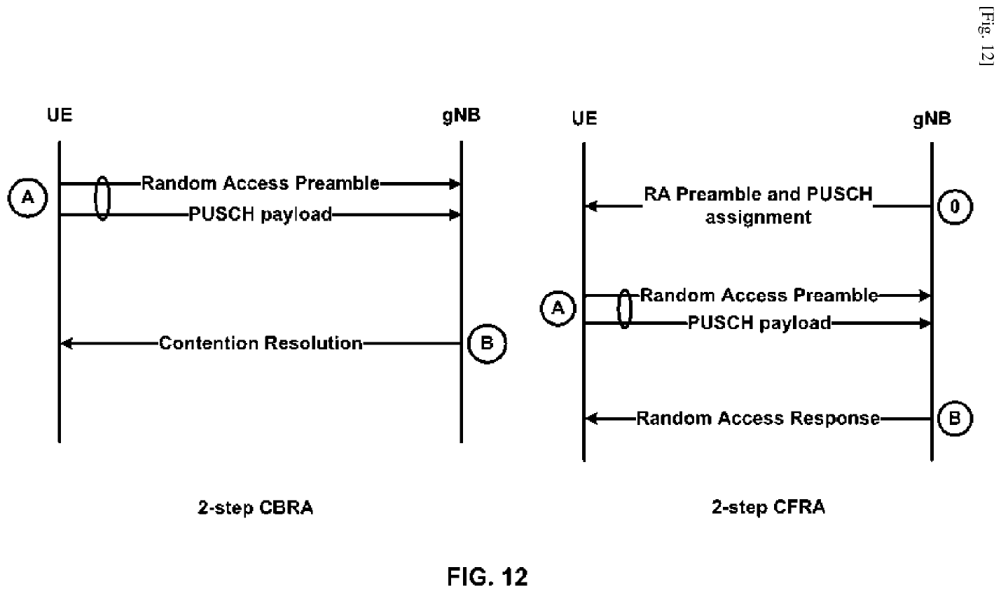

FIG. 11 shows example four-step contention-based and contention-free random access processes according to some aspects of one or more exemplary embodiments of the present disclosure. FIG. 12 shows example two-step contention-based and contention-free random access processes according to some aspects of one or more exemplary embodiments of the present disclosure. The random access procedure may be triggered by a number of events, for example: Initial access from RRC Idle State; RRC Connection Re-establishment procedure; downlink or uplink data arrival during RRC Connected State when uplink synchronization status is “non-synchronized”; uplink data arrival during RRC Connected State when there are no PUCCH resources for Scheduling Request (SR) available; SR failure; Request by RRC upon synchronous reconfiguration (e.g. handover); Transition from RRC Inactive State; to establish time alignment for a secondary TAG; Request for Other System Information (SI); Beam Failure Recovery (BFR); Consistent uplink Listen-Before-Talk (LBT) failure on PCell.

Two types of Random Access (RA) procedure may be supported: 4-step RA type with MSG1 and 2-step RA type with MSGA. Both types of RA procedure may support Contention-Based Random Access (CBRA) and Contention-Free Random Access (CFRA) as shown in FIG. 11 and FIG. 12.

The UE may select the type of random access at initiation of the random access procedure based on network configuration. When CFRA resources are not configured, a RSRP threshold may be used by the UE to select between 2-step RA type and 4-step RA type. When CFRA resources for 4-step RA type are configured, UE may perform random access with 4-step RA type. When CFRA resources for 2-step RA type are configured, UE may perform random access with 2-step RA type.

The MSG1 of the 4-step RA type may consist of a preamble on PRACH. After MSG1 transmission, the UE may monitor for a response from the network within a configured window. For CFRA, dedicated preamble for MSG1 transmission may be assigned by the network and upon receiving Random Access Response (RAR) from the network, the UE may end the random access procedure as shown in FIG. 11. For CBRA, upon reception of the random access response, the UE may send MSG3 using the uplink grant scheduled in the random access response and may monitor contention resolution as shown in FIG. 11. If contention resolution is not successful after MSG3 (re)transmission(s), the UE may go back to MSG1 transmission.

The MSGA of the 2-step RA type may include a preamble on PRACH and a payload on PUSCH. After MSGA transmission, the UE may monitor for a response from the network within a configured window. For CFRA, dedicated preamble and PUSCH resource may be configured for MSGA transmission and upon receiving the network response, the UE may end the random access procedure as shown in FIG. 12. For CBRA, if contention resolution is successful upon receiving the network response, the UE may end the random access procedure as shown in FIG. 12; while if fallback indication is received in MSGB, the UE may perform MSG3 transmission using the uplink grant scheduled in the fallback indication and may monitor contention resolution. If contention resolution is not successful after MSG3 (re)transmission(s), the UE may go back to MSGA transmission.

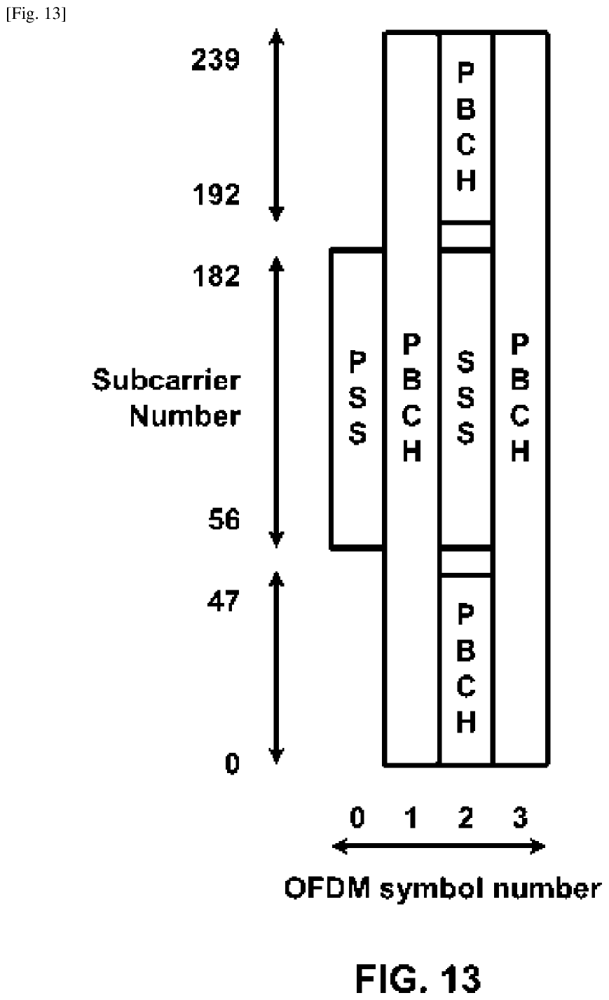

FIG. 13 shows example time and frequency structure of Synchronization Signal and Physical Broadcast Channel (PBCH) Block (SSB) according to some aspects of one or more exemplary embodiments of the present disclosure. The SS/PBCH Block (SSB) may consist of Primary and Secondary Synchronization Signals (PSS, SSS), each occupying 1 symbol and 127 subcarriers (e.g., subcarrier numbers 56 to 182 in FIG. 13), and PBCH spanning across 3 OFDM symbols and 240 subcarriers, but on one symbol leaving an unused part in the middle for SSS as show in FIG. 13. The possible time locations of SSBs within a half-frame may be determined by sub-carrier spacing and the periodicity of the half-frames, where SSBs are transmitted, may be configured by the network. During a half-frame, different SSBs may be transmitted in different spatial directions (i.e. using different beams, spanning the coverage area of a cell).

The PBCH may be used to carry Master Information Block (MIB) used by a UE during cell search and initial access procedures. The UE may first decode PBCH/MIB to receive other system information. The MIB may provide the UE with parameters required to acquire System Information Block 1 (SIB1), more specifically, information required for monitoring of PDCCH for scheduling PDSCH that carries SIB1. In addition, MIB may indicate cell barred status information. The MIB and SIB1 may be collectively referred to as the minimum system information (SI) and SIB1 may be referred to as remaining minimum system information (RMSI). The other system information blocks (SIBs) (e.g., SIB2, SIB3, . . . , SIB10 and SIBpos) may be referred to as Other SI. The Other SI may be periodically broadcast on DL-SCH, broadcast on-demand on DL-SCH (e.g., upon request from UEs in RRC Idle State, RRC Inactive State, or RRC connected State), or sent in a dedicated manner on DL-SCH to UEs in RRC Connected State (e.g., upon request, if configured by the network, from UEs in RRC Connected State or when the UE has an active BWP with no common search space configured).

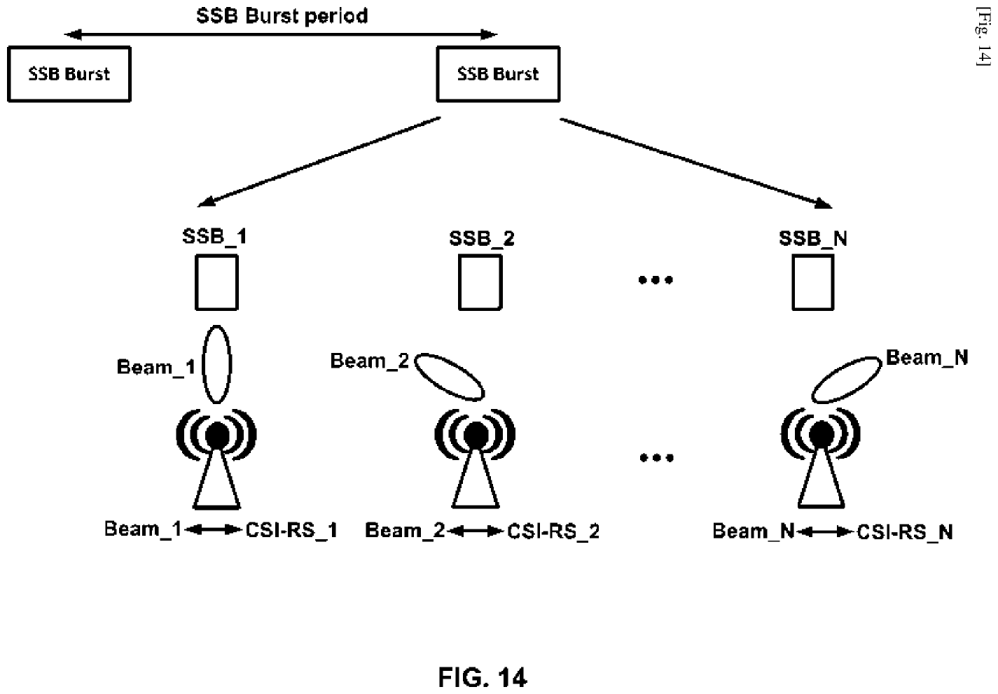

FIG. 14 shows example SSB burst transmissions according to some aspects of one or more exemplary embodiments of the present disclosure. An SSB burst may include N SSBs and each SSB of the N SSBs may correspond to a beam. The SSB bursts may be transmitted according to a periodicity (e.g., SSB burst period). During a contention-based random access process, a UE may perform a random access resource selection process, wherein the UE first selects an SSB before selecting a RA preamble. The UE may select an SSB with an RSRP above a configured threshold value. In some embodiments, the UE may select any SSB if no SSB with RSRP above the configured threshold is available. A set of random access preambles may be associated with an SSB. After selecting an SSB, the UE may select a random access preamble from the set of random access preambles associated with the SSB and may transmit the selected random access preamble to start the random access process.

In some embodiments, a beam of the N beams may be associated with a CSI-RS resource. A UE may measure CSI-RS resources and may select a CSI-RS with RSRP above a configured threshold value. The UE may select a random access preamble corresponding to the selected CSI-RS and may transmit the selected random access process to start the random access process. If there is no random access preamble associated with the selected CSI-RS, the UE may select a random access preamble corresponding to an SSB which is Quasi-Collocated with the selected CSI-RS.

In some embodiments, based on the UE measurements of the CSI-RS resources and the UE CSI reporting, the base station may determine a Transmission Configuration Indication (TCI) state and may indicate the TCI state to the UE, wherein the UE may use the indicated TCI state for reception of downlink control information (e.g., via PDCCH) or data (e.g., via PDSCH). The UE may use the indicated TCI state for using the appropriate beam for reception of data or control information. The indication of the TCI states may be using RRC configuration or in combination of RRC signaling and dynamic signaling (e.g., via a MAC Control element (MAC CE) and/or based on a value of field in the downlink control information that schedules the downlink transmission). The TCI state may indicate a Quasi-Colocation (QCL) relationship between a downlink reference signal such as CSI-RS and the DM-RS associated with the downlink control or data channels (e.g., PDCCH or PDSCH, respectively).

In some embodiments, the UE may be configured with a list of up to M TCI-State configurations, using Physical Downlink Shared Channel (PDSCH) configuration parameters, to decode PDSCH according to a detected PDCCH with DCI intended for the UE and the given serving cell, where M may depends on the UE capability. Each TCI-State may contain parameters for configuring a QCL relationship between one or two downlink reference signals and the DM-RS ports of the PDSCH, the DM-RS port of PDCCH or the CSI-RS port(s) of a CSI-RS resource. The quasi co-location relationship may be configured by one or more RRC parameters. The quasi co-location types corresponding to each DL RS may take one of the following values: ‘QCLTypeA’: {Doppler shift, Doppler spread, average delay, delay spread}; ‘QCL-TypeB’: {Doppler shift, Doppler spread}; ‘QCL-TypeC’: {Doppler shift, average delay}; ‘QCLTypeD’: {Spatial Rx parameter}. The UE may receive an activation command (e.g., a MAC CE), used to map TCI states to the codepoints of a DCI field.

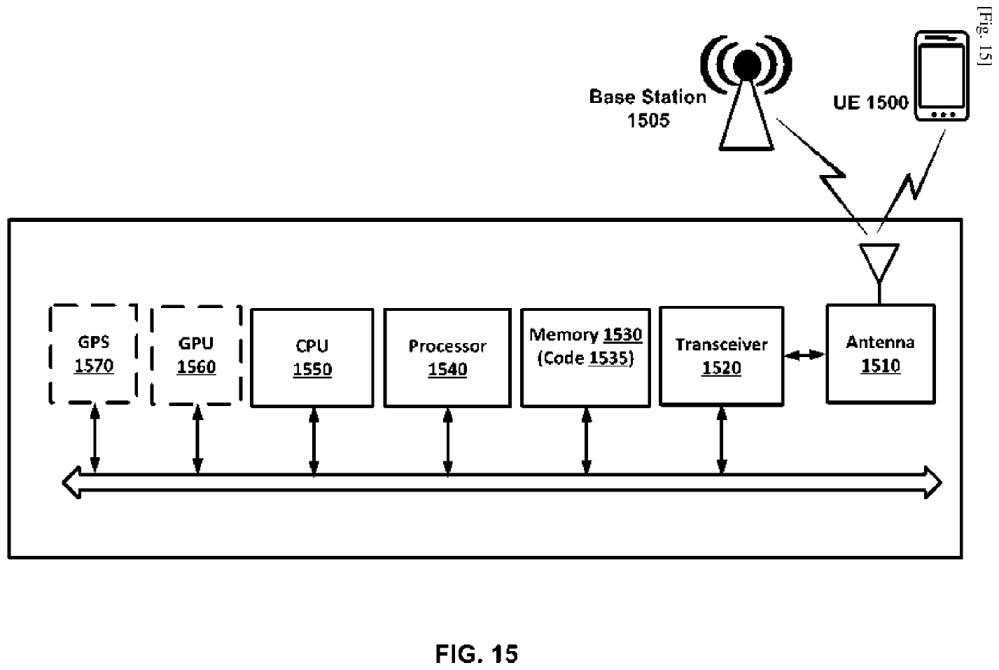

FIG. 15 shows example components of a user equipment and a base station for transmission and/or reception according to some aspects of one or more exemplary embodiments of the present disclosure. In one embodiment, the illustrative components of FIG. 15 may be considered to be illustrative of functional blocks of an illustrative base station 1505. In another embodiment, the illustrative components of FIG. 15 may be considered to be illustrative of functional blocks of an illustrative user equipment 1500. Accordingly, the components illustrated in FIG. 15 are not necessarily limited to either a user equipment or base station.

As illustrated in FIG. 15, the Antenna 1510 may be used for transmission or reception of electromagnetic signals. The Antenna 1510 may comprise one or more antenna elements and may enable different input-output antenna configurations including Multiple-Input Multiple Output (MIMO) configuration, Multiple-Input Single-Output (MISO) configuration and Single-Input Multiple-Output (SIMO) configuration. In some embodiments, the Antenna 150 may enable a massive MIMO configuration with tens or hundreds of antenna elements. The Antenna 1510 may enable other multi-antenna techniques such as beamforming. In some examples and depending on the UE 1500 capabilities or the type of UE 1500 (e.g., a low-complexity UE), the UE 1500 may support a single antenna only.

The transceiver 1520 may communicate bi-directionally, via the Antenna 1510, wireless links as described herein. For example, the transceiver 1520 may represent a wireless transceiver at the UE and may communicate bi-directionally with the wireless transceiver at the base station or vice versa. The transceiver 1520 may include a modem to modulate the packets and provide the modulated packets to the Antennas 1510 for transmission, and to demodulate packets received from the Antennas 1510.

The memory 1530 may include RAM and ROM. The memory 1530 may store computer-readable, computer-executable code 1535 including instructions that, when executed, cause the processor to perform various functions described herein. In some embodiments, the memory 1530 may contain, among other things, a Basic Input/output System (BIOS) which may control basic hardware or software operation such as the interaction with peripheral components or devices.

The processor 1540 may include a hardware device with processing capability (e.g., a general purpose processor, a DSP, a CPU, a microcontroller, an ASIC, an FPGA, a programmable logic device, a discrete gate or transistor logic component, a discrete hardware component, or any combination thereof). In some examples, the processor 1540 may be configured to operate a memory using a memory controller. In other examples, a memory controller may be integrated into the processor 1540. The processor 1540 may be configured to execute computer-readable instructions stored in a memory (e.g., the memory 1530) to cause the UE 1500 or the base station 1505 to perform various functions.

The Central Processing Unit (CPU) 1550 may perform basic arithmetic, logic, controlling, and Input/output (I/O) operations specified by the computer instructions in the Memory 1530. The user equipment 1500 and/or the base station 1505 may include additional peripheral components such as a graphics processing unit (GPU) 1560 and a Global Positioning System (GPS) 1570. The GPU 1560 is a specialized circuitry for rapid manipulation and altering of the Memory 1530 for accelerating the processing performance of the user equipment 1500 and/or the base station 1505. The GPS 1570 may be used for enabling location-based services or other services for example based on geographical position of the user equipment 1500.

In some example, MBS services may be enabled via single-cell transmission. MBS may be transmitted in the coverage of a single cell. One or more Multicast/Broadcast control channels (e.g., MCCHs) and one or more Multicast/Broadcast data channels (e.g., MTCHs) may be mapped on DL-SCH. The scheduling may be done by the gNB. The Multicast/Broadcast control channel and the Multicast/Broadcast data channel transmissions may be indicated by a logical channel specific RNTI on PDCCH. In some examples, a one-to-one mapping between a service identifier such as a temporary mobile group identifier (TMGI) and a RAN level identifier such as a group identifier (G-RNTI) may be used for the reception of the DL-SCH to which a Multicast/Broadcast data channel may be mapped. In some examples, a single transmission may be used for DL-SCH associated with the Multicast/Broadcast control channel and/or the Multicast/Broadcast data channel transmissions and HARQ or RLC retransmissions may not be used and/or an RLC Unacknowledged Mode (RLC UM) may be used. In other examples some feedback (e.g., HARQ feedback or RLC feedback) may be used for transmissions via Multicast/Broadcast control channel and/or Multicast/Broadcast data channels.

In some example, for Multicast/Broadcast data channel, the following scheduling information may be provided on Multicast/Broadcast control channel: a Multicast/Broadcast data channel scheduling cycle, a Multicast/Broadcast data channel onduration (e.g., duration that the UE waits for, after waking up from DRX, to receive PDCCHs), a Multicast/Broadcast data channel inactivity timer (e.g., duration that the UE waits to successfully decode a PDCCH, from the last successful decoding of a PDCCH indicating the DL-SCH to which this Multicast/Broadcast data channel is mapped, failing which it re-enters DRX).

In some examples, one or more UE identities may be related to MBS transmissions. The one or more identities may comprise at least one of: one or more first RNTIs that identify transmissions of the Multicast/Broadcast control channel; one or more second RNTIs that identify transmissions of a Multicast/Broadcast data channels. The one or more first RNTIs that identify transmissions of the Multicast/Broadcast control channel may comprise a single cell RNTI (SC-RNTI, other names may be used). The one or more second RNTIs that identify transmissions of a Multicast/Broadcast data channels may comprise a G-RNTI (nG-RNTI or other names may be used).

In some examples, one or more logical channels may be related to MBS transmissions. The one or more logical channels may comprise a Multicast/Broadcast control channel. The Multicast/Broadcast control channel may be a point-to-multipoint downlink channel used for transmitting MBS control information from the network to the UE, for one or several Multicast/Broadcast data channel. This channel may be used by UEs that receive or are interested to receive MBS. The one or more logical channels may comprise a Multicast/Broadcast data channel. This channel may be a pointto-multipoint downlink channel for transmitting MBS traffic data from the network.

In some examples, a procedure may be used by the UE to inform RAN that the UE is receiving or is interested to receive MBS service(s) via an MBS radio bearer, and if so, to inform the 5G RAN about the priority of MBS versus unicast reception or MBS service(s) reception in receive only mode. The UE may transmit a message (e.g., an MBS interest indication message) message to inform RAN that the UE is receiving/interested to receive or no longer receiving/interested to receive MBS service(s). The UE may transmit the message based on receiving one or more messages (e.g., a SIB message or a unicast RRC message) from the network for example indicating one or more MBS Service Area Identifiers of the current and/or neighboring carrier frequencies.

In some examples, the UE may consider an MBS service to be part of the MBS services of interest if the UE is capable of receiving MBS services (e.g., via a single cell point to multipoint mechanism) the UE may be configured to receive or indicate information MBS services are of interest to the UE via a bearer associated with MBS services. Still further in other example, the UE may determine or transmit information that one session of this service is ongoing or about to start. In still other example, the UE my receive or indicate information that at least one of the one or more MBS service identifiers indicated by network is of interest to the UE.

In some examples, control information for reception of MBS services may be provided on a specific logical channel: (e.g., a MCCH). The MCCH may carry one or more configuration messages which indicate the MBS sessions that are ongoing as well as the (corresponding) information on when each session may be scheduled, e.g., scheduling period, scheduling window and start offset. The one or more configuration messages may provide information about the neighbor cells transmitting the MBS sessions which may be ongoing on the current cell. In some examples, the UE may receive a single MBS service at a time, or more than one MBS services in parallel.

In some example, the MCCH information (e.g., the information transmitted in messages sent over the MCCH) may be transmitted periodically, using a configurable repetition period. The MCCH transmissions (and the associated radio resources and MCS) may be indicated on PDCCH.

In some examples, change of MCCH information may occur at specific radio frames/subframes/slots and/or a modification period may be used. For example, within a modification period, the same MCCH information may be transmitted a number of times, as defined by its scheduling (which is based on a repetition period). The modification period boundaries may be defined by SFN values for which SFN mod m=0, where m is the number of radio frames comprising the modification period. The modification period may be configured by a SIB or by RRC signaling.

In some examples, when the network changes (some of) the MCCH information, it may notify the UEs about the change in the first subframe/slot which may be used for MCCH transmission in a repetition period. Upon receiving a change notification, a UE interested to receive MBS services may acquire the new MCCH information starting from the same subframe/slot. The UE may apply the previously acquired MCCH information until the UE acquires the new MCCH information.

In an example, a system information block (SIB) may contain the information required to acquire the control information associated transmission of MBS. The information may comprise at least one of: one or more discontinuous reception (DRX) parameters for monitoring for scheduling information of the control information associated transmission of MBS, scheduling periodicity and offset for scheduling information of the control information associated transmission of MBS, modification period for modification of content of the control information associated transmission of MBS, repetition information for repetition of the control information associated transmission of MBS, etc.

In an example, an information element (IE) may provide configuration parameters indicating, for example, the list of ongoing MBS sessions transmitted via one or more bearers for each MBS session, one or more associated RNTIs (e.g., G-RNTI, other names may be used) and scheduling information. The configuration parameters may comprise at least one of: one or more timer values for discontinuous reception (DRX) (e.g., an inactivity timer or an On Duration timer), an RNTI for scrambling the scheduling and transmission of a Multicast/Broadcast traffic channel (e.g., MTCH, other names may be used), ongoing MBS session, one or more power control parameters, one or more scheduling periodicity and/or offset values for one or more MBS traffic channels, information about list of neighbor cells, etc.

In some examples, a UE may monito a set of PDCCH candidates in the configured monitoring occasions in one or more configured COntrol REsource SETs (CORESETs) according to the corresponding search space configurations. A CORESET may comprised a set of physical resource blocks (PRBs) with a time duration of 1 to 3 OFDM symbols. The resource units Resource Element Groups (REGs) and Control Channel Elements (CCEs) may be defined within a CORESET with each CCE comprising a set of REGs. Control channels may be formed by aggregation of CCE. Different code rates for the control channels may be realized by aggregating different number of CCE. Interleaved and non-interleaved CCE-to-REG mapping may be supported in a CORESET.

In some example, an information element (IE) MeasIdleConfig may be used to convey information to UE about measurements requested to be done while in RRC_IDLE or RRC_INACTIVE. Example parameters if the MeasIdleConfig IE may include the following parameters. Additional parameters for measurements related to MBS services/sessions during the RRC IDLE or RRC INACTIVE state may be used in addition or instead of one or more of the following parameters. The parameters include:

A parameter absThreshSS-BlocksConsolidation may indicate threshold for consolidation of L1 measurements per RS index. A parameter beamMeasConfigIdle may indicate the beam level measurement configuration. A parameter carrierFreq may indicate the NR carrier frequency to be used for measurements during RRC_IDLE or RRC_INACTIVE. A parameter carrierFreqEUTRA may indicate the E-UTRA carrier frequency to be used for measurements during RRC_IDLE or RRC_INACTIVE. A parameter deriveSSB-IndexFromCell may indicate whether the UE may use the timing of any detected cell on that frequency to derive the SSB index of all neighbour cells on that frequency. If this field is set to true, the UE may assume system fram enumber (SFN) and frame boundary alignment across cells on the neighbor frequency. A parameter frequencyBandList may indicate the list of frequency bands for which the NR idle/inactive measurement parameters may apply. The UE may select the first listed band which it supports in the frequencyBandList field to represent the NR neighbour carrier frequency. A parameter includeBeamMeasurements may indicate whether or not the UE may include beam measurements in the NR idle/inactive measurement results. A parameter maxNrofRS-IndexesToReport may indicate max number of beam indices to include in the idle/inactive measurement result. A parameter measCellListEUTRA may indicate the list of E-UTRA cells which the UE is requested to measure and report for idle/inactive measurements. A parameter measIdleCarrierListNR may indicate the NR carriers to be measured during RRC_IDLE or RRC_INACTIVE. A parameter measIdleDuration may indciate the duration for performing idle/inactive measurements while in RRC_IDLE or RRC_INACTIVE. A parameter nrofSS-BlocksToAverage may indicate number of SS blocks to average for cell measurement derivation. A parameter qualityThreshold may indicate the quality thresholds for reporting the measured cells for idle/inactive NR measurements. A parameter qualityThresholdEUTRA may indicate the quality thresholds for reporting the measured cells for idle/inactive E-UTRA measurements. A parameter reportQuantities may indicate which measurement quantities UE is requested to report in the idle/inactive measurement report. A parameter reportQuantitiesEUTRA may indicate which E-UTRA measurement quantities the UE is requested to report in the idle/inactive measurement report. A parameter reportQuantityRS-Indexes may indicate which measurement information per beam index the UE shall include in the NR idle/inactive measurement results. A parameter smtc may indicate the measurement timing configuration for inter-frequency measurement. A parameter ssbSubcarrierSpacing may indicate subcarrier spacing of SSB. A parameter ssb-ToMeasure may indicate the set of SS blocks to be measured within the SMTC measurement duration. A parameter ss-RSSI-Measurement may indicate the SSB-based RSSI measurement configuration. A parameter validityAreaList may indicate the list of frequencies and optionally, for each frequency, a list of cells within which the UE is required to perform measurements while in RRC IDLE and RRC INACTIVE.

In some examples, a SIB (e.g., SIB11) may contain information related to idle/inactive measurements. A parameter/IE measIdleConfigSIB may indicate measurement configuration to be stored and used by the UE while in RRC_IDLE or RRC_INACTIVE.

In some examples, in RRC_IDLE state, the UE may not be registered to a particular cell, hence the UE may not have an AS context and other information received from the network. The network may initiate the RRC connection release procedure to transit a UE in RRC_CONNECTED to RRC_IDLE state. The UE may be wake up periodically (according to a configured DRX cycle) and may monitor for paging messages from the network. The network may reach UEs in RRC_IDLE state through Paging messages, and to notify UEs in RRC_IDLE change of system information change and other indications through Short Messages. Both Paging messages and Short Messages may be addressed with P-RNTI on PDCCH. The paging message may be sent on PCCH and the Short Messages may be sent over PDCCH.

In some examples, while in RRC_IDLE, the UE may monitor the paging channels for CN-initiated paging. In RRC_INACTIVE state, the UE may monitor paging channels for RAN-initiated paging. A UE may not monitor paging channels continuously. A paging DRX may be used where the UE in RRC_IDLE or RRC_INACTIVE may monitor paging channels during a Paging Occasion (PO) per DRX cycle.

In some examples, in RRC IDLE state, the UE may manage mobility based on the network configurations via cell (re-) selections. The UE may perform the neighboring cell measurements for cell (re-) selections.

In some examples, on transition from RRC_CONNECTED or RRC_INACTIVE to RRC_IDLE, a UE may camp on a cell as result of cell selection according to the frequency assigned by RRC in a state transition message.

In some examples, in RRC_IDLE state, the UE may not transmit in the uplink except for PRACH initiated when UE desires to transit to RRC_CONNECTED state or to request for on-demand system information.

In some examples, RRC_INACTIVE state may be used to reduce network signaling load and reduce latency involved in transitioning to RRC_CONNECTED state. In RRC_INACTIVE state, the AS context may be stored by both UE and gNB. The state transition from inactive state to connected state may be faster than state transition from RRC IDLE state to RRC Connected state. In some examples, the core network connection may be maintained in RRC Inactive state (e.g., the UE may remain in CMCONNECTED).

In some examples, the UE in RRC Inactive state may wake up periodically (e.g., according to configured DRX cycle) and may monitor for paging messages from the network. The network may reach UEs in RRC_INACTIVE state through Paging messages, and may notify UEs in RRC_INACTIVE, change of system information and other indications through Short Messages. The Paging messages and Short Messages may be addressed with P-RNTI on PDCCH, and sent on PCCH and PDCCH respectively.

In some examples, the UE may monitor a Paging channel for CN paging using 5G-S-TMSI and RAN paging using fullI-RNTI (Inactive RNTI). I-RNTI may be used to identify the suspended UE context of a UE in RRC_INACTIVE state. The network may assign I-RNTI to the UE when moving from RRC_CONNECTED to RRC_INACTIVE state in RRCRelease message within SuspendConfig.

In some examples, in RRC_INACTIVE state, the UE may not transmit in the uplink except for PRACH initiated when UE desires to transit to RRC_CONNECTED state (to transmit RRCResumeRequest) or to request for on-demand system information.

In some examples, the gNB may send a UE from RRC_CONNECTED to RRC_INACTIVE state by transmitting RRCRelease message with suspendConfig.

The field suspendConfig may provide the UE with the required configuration for the RRC_INACTIVE state and my indicate a full I-RNTI, a short I-RNTI, a ranNotofocationArealnfo, a ran-PagingCycle, a timer value for triggering periodic RNA update, etc.

In some examples, the resumption of a suspended RRC connection may be initiated by upper layers when the UE needs to transit from RRC_INACTIVE state to RRC_CONNECTED state or by RRC layer to perform an RNA update or by RAN paging from NG-RAN. The RRC connection resume procedure may re-activate AS security and re-establishes signaling radio bearer(s) (SRB(s)) and data radio bearers (DRB(s)).

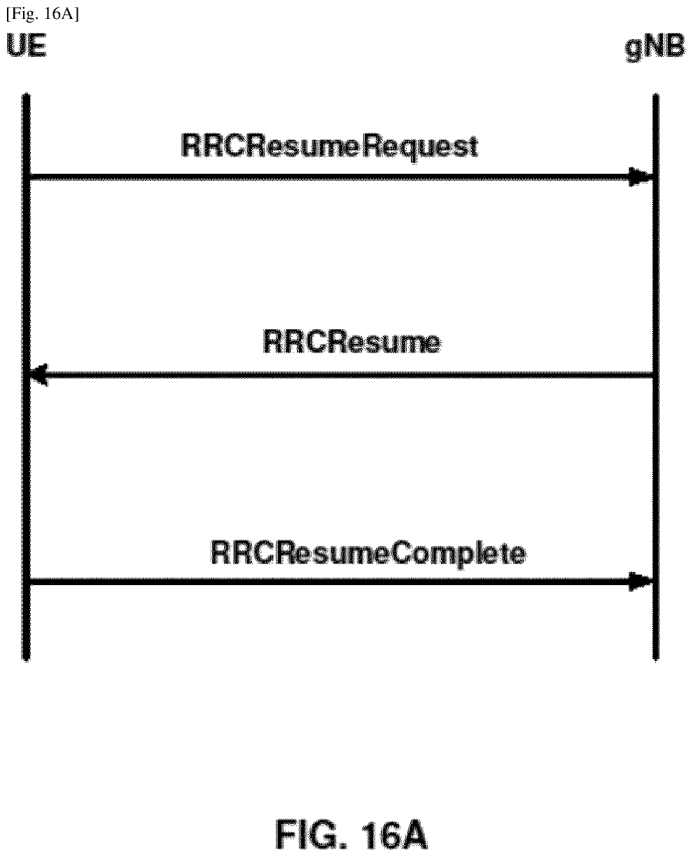

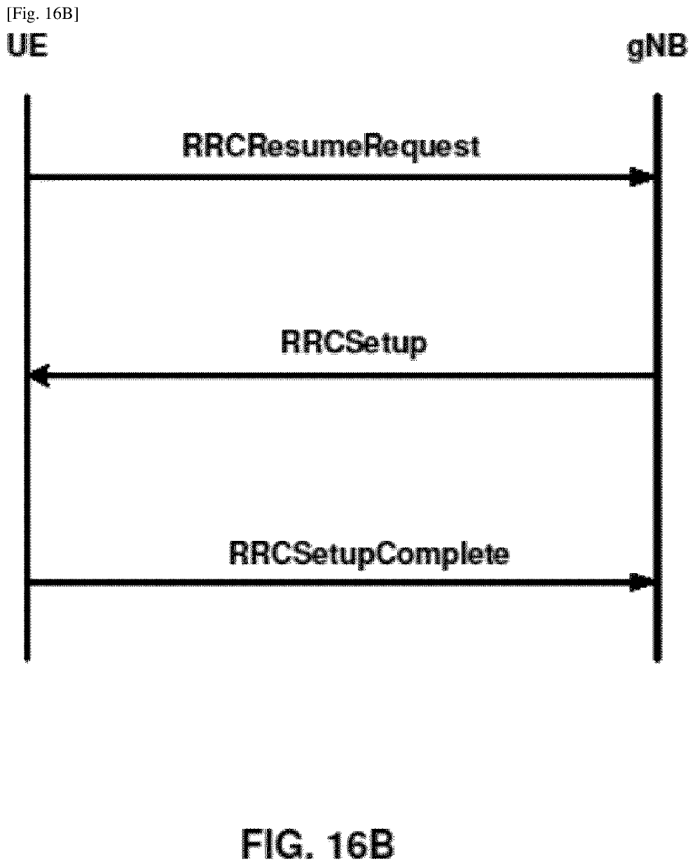

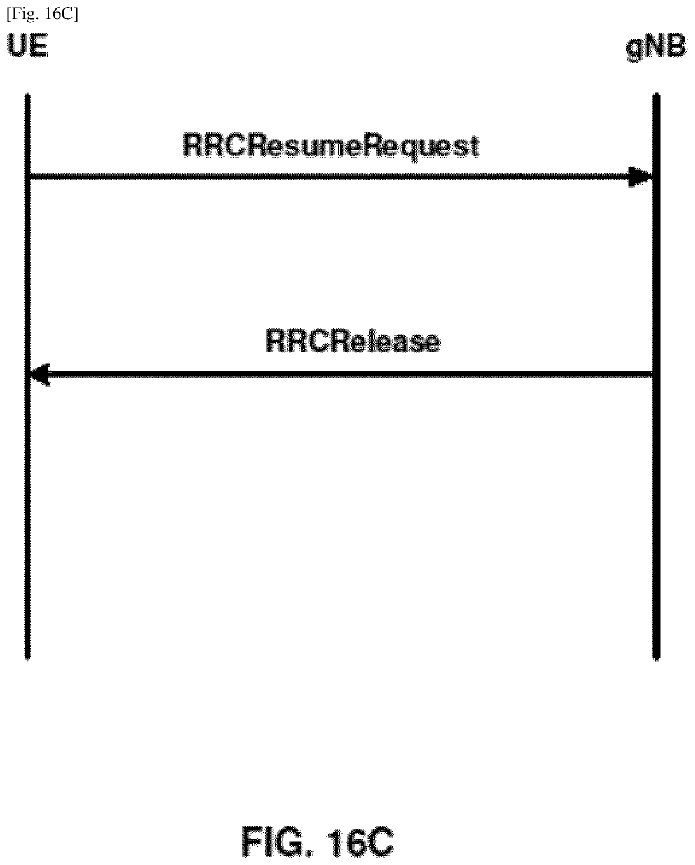

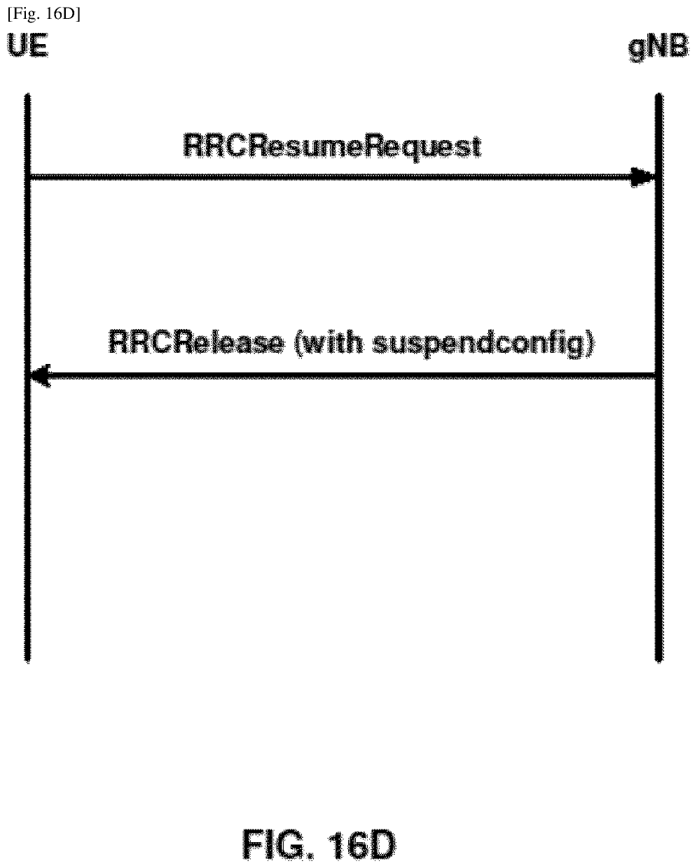

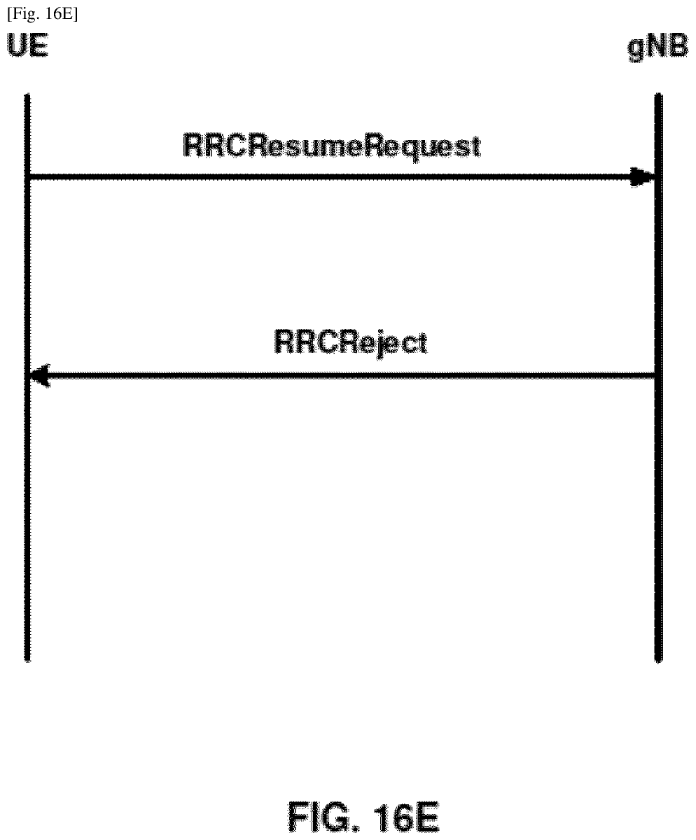

In some examples as shown in FIG. 16A-FIG. 16E, in response to a request to resume the RRC connection, the network may resume the suspended RRC connection and may send UE to RRC_CONNECTED, or may reject the request to resume and send UE to RRC_INACTIVE (e.g., with a wait timer), or may re-suspend the RRC connection and may send UE to RRC_INACTIVE, or may release the RRC connection and send UE to RRC_IDLE, or may instruct the UE to initiate NAS level recovery (in this case the network may send an RRC setup message). The first scenario (FIG. 16A) may result in successful RRC connection resumption (e.g., transition from RRC_INACTIVE to RRC_CONNECTED). The second scenario (FIG. 16B) may result in RRC connection resume fallback to RRC connection establishment (e.g., transition from RRC_INACTIVE to RRC_CONNECTED). The third scenario (FIG. 16C), may result in RRC connection resume followed by network releasing RRC connection (e.g., transition from RRC_INACTIVE to RRC_IDLE). The fourth scenario (FIG. 16D) may result in RRC connection resume followed by network suspend (e.g., transition from RRC_INACTIVE to RRC_INACTIVE). The fifth scenario (FIG. 16E) may result in RRC connection resume followed by network reject (e.g., transition from RRC_INACTIVE to RRC_INACTIVE). The RRC connection resumption procedure may trigger a random access procedure. For example, the UE may transmit an RRCResumeRequest (UL CCCH) message in MSG3 or MsgA.

In some examples, a ResumeCause field may indicate one of the following or may indicate other parameters associated with MBS services and/or MBS service continuity: emergency, highPriorityAccess, mt-Access, mo-Signalling, mo-Data, moVoiceCall, mo-VideoCall, mo-SMS, ma-Update, mps-PriorityAccess, or mcsPriorityAccess.

After receiving resume request from the UE, the network may send RRCResume (DCCH) to resume suspended RRC Connection. The UE may confirm successful completion of an RRC connection resumption procedure by sending RRCResumeComplete (DCCH) message.

In some examples, in RRC_INACTIVE state, the UE may remain in CMCONNECTED and may move within an area configured by NG-RAN (the ran notification area (RNA)) without notifying NG-RAN. In this state, the last serving gNB node may keep the UE context and the UE-associated NG connection with the serving AMF and UPF. If the last serving gNB receives downlink data from the UPF or downlink UE-associated signaling from the AMF, it pages in the cells corresponding to the RNA and may send Xn-AP RAN Paging to neighbor gNB(s) if the RNA includes cells of neighbor gNB(s).

In some examples, a UE in the RRC_INACTIVE state may be configured (e.g., in RRCRelease message via suspendConfig) by the last serving NG-RAN node with an RNA, where: the RNA may cover a single or multiple cells, and may be contained within a CN registration area. A RAN-based notification area update (RNAU) may be periodically sent by the UE. In some examples, RNAU may be sent when the UE reselects a cell that does not belong to the configured RNA.

In some examples, while transitioning the UE to RRC_INACTIVE, the NG-RAN node may configure the UE with a periodic RNA Update timer value (e.g., t380). Upon the expiry of this periodic timer, the UE may initiate RRC Connection Resume procedure with resumeCause set to rna-udpate.

In some examples, a UE in the RRC_INACTIVE state may initiate RNA update procedure (e.g., resumeCause set to ma-Update) when it moves out of the configured RNA i.e., the serving cell may not belong to the configured ran-NotificationArealnfo.

In some examples, when receiving RNA update request from the UE, the receiving gNB may trigger the Xn-AP Retrieve UE Context procedure to get the UE context from the last serving gNB and may decide to send the UE back to RRC_INACTIVE state, move the UE into RRC_CONNECTED state, or send the UE to RRC_IDLE.

In some examples, if the UE accesses a gNB other than the last serving gNB, the receiving gNB may trigger the Xn-AP Retrieve UE Context procedure to get the UE context from the last serving gNB. If the UE accesses a gNB other than the last serving gNB and the receiving gNB does not find a valid UE Context, the receiving gNB may perform establishment of a new RRC connection instead of resumption of the previous RRC connection.

In some examples, Multicast and Broadcast Service (MBS) may use a Single Cell Single Cell Point-to-Multipoint (SC-PTM) framework. The SC-PTM may be used for eMBMS services, Mission Critical Push-to-Talk (MCPTT), Internet of Things (IoT), and also Vehicle-to-everything (V2X). Example solutions for service continuity and handover procedures do not take into account UE and service mobility for MBS services/sessions for UEs in RRC inactive state or UEs in RRC idle state. There is a need to maintain service continuity and mobility for MBS services for UEs in RRC idle and RRC inactive state. Example embodiments enable service continuity and mobility for MBS services/sessions for UEs in RRC idle and RRC inactive state.

Considering the wide range of MBS services and 5G emphasis on power saving, it also important to maintain MBS service continuity and mobility for UE's in idle and inactive state while maximizing commonality with connected state mobility. In some examples, such mobility support for idle/inactive UEs may not be needed for all MBS services and may not support the same way for all UEs. In some example, the level of mobility support for an MBS service may be configurable per MBS service and/or per UE.

In some examples, for some MBS services, e.g. those with low duty cycles, the UEs may receive the MBS data in Connected as well as in Idle/Inactive state even as they move to other cells. This may be a QoS parameter which may be set per service and/or per user.

In some examples, support for service continuity with mobility may be enabled only for UEs in RRC Inactive state, or only for UEs in RRC idle mode state or may be enabled for UEs in both RRC inactive state and RRC idle states.

In some examples, support for Service Continuity (SC) for an MBS service in general and its support for UE's in Idle/Inactive state may be a QoS parameter which may be configured per service and/or per UE.

In some examples, for an MBS with SC option the geographic area where such service may be expected by UE may be set by application layer signaling. The UEs may determine if its target MBS service is offered in neighboring cells using its geolocation or based on configuration information received from the serving/selected (target) cell.

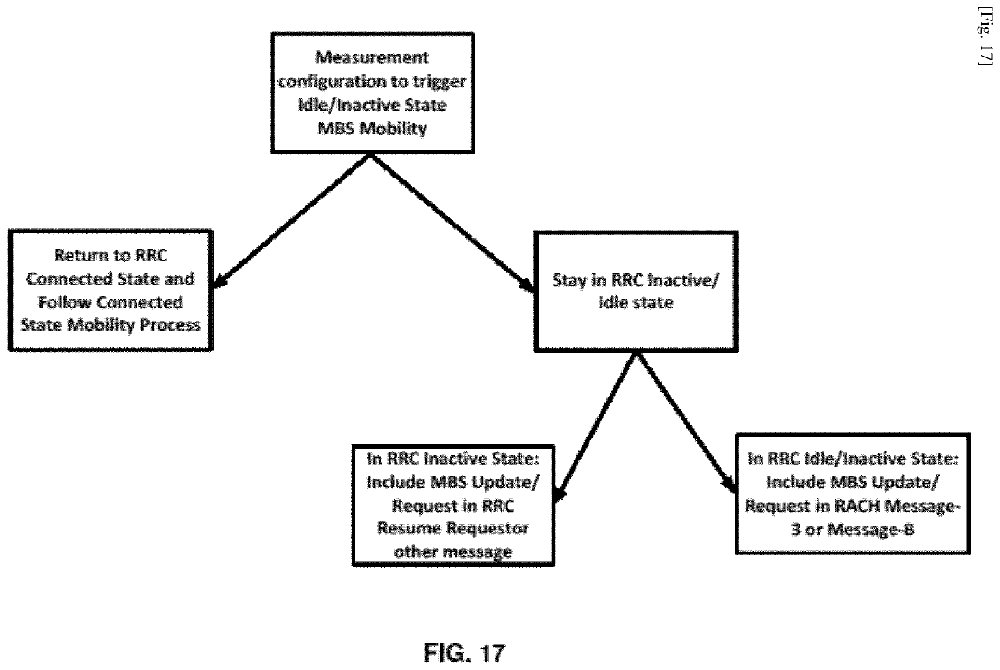

Example processes for MBS service continuity in RRC Inactive state or RRC Idle state are shown in FIG. 17. In some examples, a UE may be configured with measurement and triggering events and the UE may indicate to the RAN about need for MBS service continuity when the UE moving to a target cell while in RRC Idle or RRC Inactive states.

In some examples, the UEs in RRC Inactive/Idle state may be configured with MBS service continuity MBS-SC measurements and triggers to initiate the MBS service continuity process. In some examples, the measurement thresholds types and/or events may be specific to MBS service continuity. In some examples, the threshold types and/or events may have different values that the values configured for cell (re)selection in RRC Idle or RRC Inactive states.

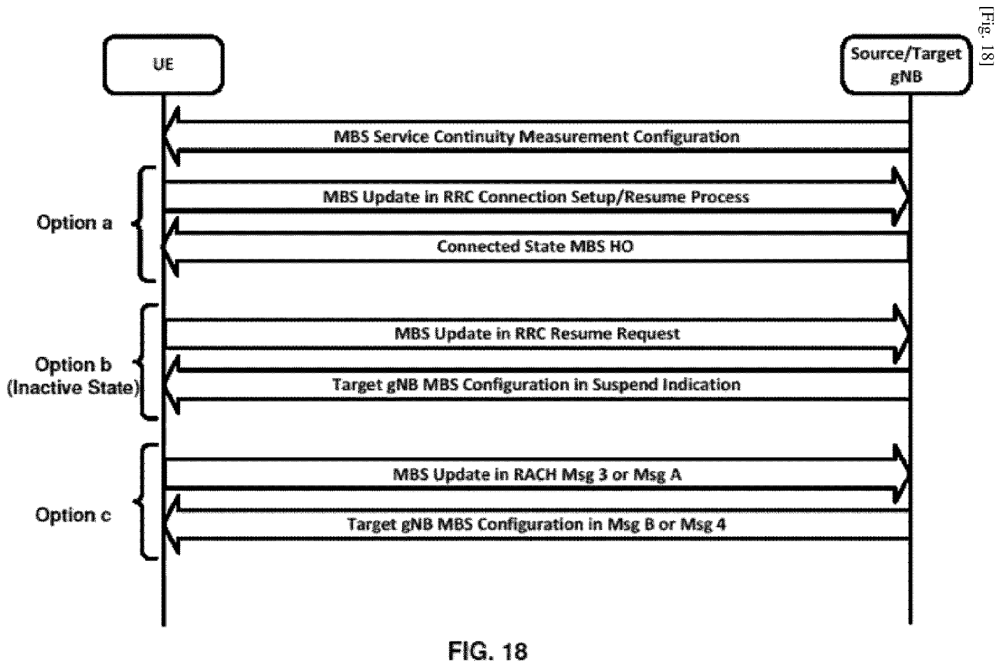

Example options for MBS service continuity in RRC Inactive state or RRC Idle state is shown in FIG. 18. In some example, once the UE determines that its MBS service continuity needs attention by the RAN it may initiate a procedure which may or may not require UE to return to connected state. In some examples (e.g., option a in FIG. 18), for a UE in RRC Inactive/Idle state, based on observing the MBS SC triggers, the UE may return to RRC Connected State and may use connected state mobility procedures for MBS HO to target cell. In some examples (e.g., option b in FIG. 18), a UE in RRC inactive state, based on observing the MBS SC triggers, may send an update to RAN, e.g. based on RAN Notification Area (RNA) update RNA Update in RRCResumeRequest or other procedures to indicate their transition to a target cell without leaving the RRC inactive state. In some examples, this process may allow such UE's MBS context as part of UE's RAN context to be shared with target cell without UE returning to connected state. If the MBS configuration, e.g. BWP, Subframes, slot duration/format, etc., are different in the target cell, such information may be included in the RRC signaling back to UE, e.g. as part of Suspend Indication message. In some examples (e.g., option c in FIG. 18), a UE in RRC Inactive or RRC Idle state, based on observing the MBS SC triggers, may send an update using a RACH based signaling and may indicate network about UE's leaving a source cell toward a target and the MBS services the UE is receiving. Such signaling may reuse Message A of 2-step RACH or message 3 of 4 step RACH procedure. Similar to option b, based on receiving this RACH signal, the RAN may send an RRC message to the UE, e.g. message B in 2-step RACH process or message 4 in a 4-step RACH process, including information needed by UE to determine the MBS services in target cell. The 2-step RACH procedure may be more efficient to reduce signaling, where message A from UE may include some identifier for the UE and target MBS services and message B from RAN may include MBS configuration for UE's selected services in the target cell.

In some examples, the UE may initiate the signaling with source cell and the source cell may request MBS configuration of the target cell. The source cell may receive the MBS configuration of the target cell and may second the MBS configurations of the target cell to the UE. In some examples, the UE may initiate the signaling first with the target cell and the target cell may get UE's MBS context from source cell. The UE may continue receiving its MBS data during the transition.

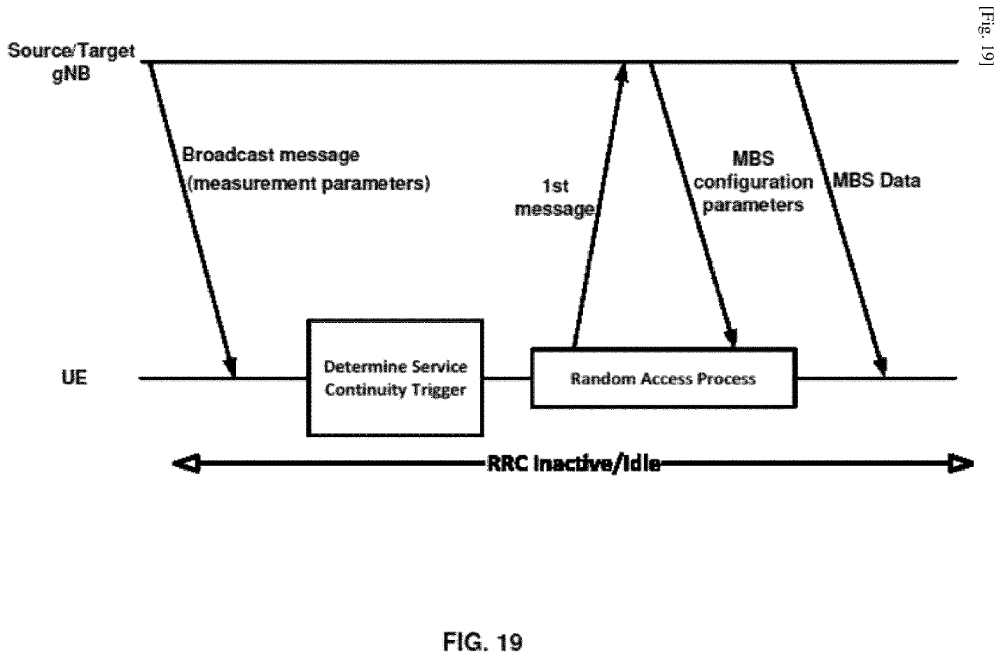

In an example embodiment as shown in FIG. 19, a UE may be in an RRC Inactive or an RRC Idle state. The UE may transition to the RRC Inactive or the RRC Idle state from an RRC connected state based on receiving an RRC message (e.g., an RRC release message) indicating release of the RRC configurations or suspending the RRC configurations. For example, a suspend configuration information element in the RRC release message may indicate one or more RNTIs for identifying suspended UE context in the RRC Inactive state and/or receiving paging information; RAN notification area information, paging cycle for RAN initiated paging, one or more timers for UE operation during the RRC Inactive state, etc. The UE that transitions to the RRC inactive state may keep the UE context and the last serving gNB may keep the UE context. In some examples, a second gNB may request the UE context from the last serving gNB (e.g., the last serving gNB before transitioning to the RRC inactive state) and the second gNB may receive the UE context from the last serving gNB using Xn signaling. In some examples, the second gNB may receive UE context associated with MBS services from the last serving gNB.

While in the RRC Idle state or the RRC Inactivate state, the UE may receive a broadcast message (e.g., a system information block (SIB) message such as SIB11) comprising measurement configuration parameters. For example, the broadcast message (e.g., a SIB message, e.g., SIB11) may comprise a MeasIdleConfig information element or a MeasIdleConfigSIB information element that indicate one or more thresholds for L1 measurements, beam level configuration parameters, carrier frequency to be used for measurements during RRC IDLE or RRC INACTIVE states, the list of frequency bands for which the idle/inactive measurement parameters apply, one or more parameters indicating whether or not the UE may include beam measurements in the NR idle/inactive measurement results, the duration for performing idle/inactive measurements while in RRC IDLE or RRC INACTIVE, number of SS blocks to average for cell measurement derivation, one or more subcarrier spacing parameter, etc.

The UE may determine a service continuity trigger (e.g., a need for a new need cell (re)selection) for one or more MBS services/sessions based on the measurement configuration parameters. For example, the service continuity trigger may indicate a need for handover to a target cell at least for the one or more MBS services/sessions. For example, the UE may determine the service continuity trigger based on measuring one or more synchronization signal/PBCH blocks (SSBs) and by comparing a value (e.g., an average) determined based on the measuring the one or more SSBs (e.g., reference signal reference power (RSRP) and/or received signal received quality (RSRQ) of the one or more SSBs). In some examples, the service continuity trigger may be MBS services-specific for example, the thresholds and/or other parameters associated with determining the service continuity trigger may be specific to MBS services and may be different for other services/sessions (e.g., unicast services/sessions). In some examples, the service continuity trigger may be MBS service specific, for example, the thresholds and/or other parameters associated with determining the service continuity trigger may be different for different MBS services. In some example, the service continuity triggers may be independent of UE's ongoing services/sessions and may be UE-specific and not service/session-specific.

The UE may start a random access process in response to determining the service continuity trigger for the one or more MBS services/sessions. In some examples, a random access preamble used by the UE in the random access process (e.g., a random access process by a UE in an RRC inactive and/or RRC idle state) may indicate that the random access process is associated with MBS services (e.g., service continuity for MBS services/sessions). For example, the gNB providing the cell on which the random access preamble is transmitted (e.g., the cell that the UE is camped on) or the target cell may determine that the random access process is associated with MBS services (e.g., MBS service continuity) based on the selected random access preamble.

A group of pre-configured/configured random access preambles may be associated with the MBS services/sessions. The UE may transmit a first message, based on the random access process, indicating a request for MBS configuration parameters associated with the one or more MBS service via the target cell. For example, the UE may transmit the first message based on a Msg3 in a 4-step random access process or a MsgA in a 2-step random access process. The first message may comprise one or more service identifier (e.g., temporary mobile group identifier (TMGIs)) indicating MBS services that the UE is receiving from a currently camped on cell or the MBS services that the UE is interested in receiving from the target cell (e.g., MBS services for which service continuity is requested). In some examples, a Quality of Service (QoS) associated with an MBS service/session (e.g., an MBS bearer) may indicate whether the MBS service/session requires service continuity (for example, service continuity in idle and/or inactive state) and the UE and/or the gNB may consider the QoS requirements of the MBS bearer in transmission of the first message or admission control by the target cell. The first message may comprise one or more fields, one or more values of the one or more fields associated with the determined service continuity trigger and/or the need for service continuity for the one or more MBS services. For example, the one or more fields may comprise a cause field indicating a cause for transmission of the first message. For example, the first message may be transmitted in other procedures and/or for other reasons and the value of the cause field may indicate the cause for transmission of the first message. For example, in case of the UE being in an RRC inactive state, the first message may be an RRC resume request message with the value of the cause field (e.g., a resume cause field) indicating the cause for transmission of the first message is for service continuity associated with the one or more MBS services. The value of the cause field may indicate that the cause for transmission of the first message is for service continuity associated with the one or more MBS services while remaining in the RRC inactive state.

In response to transmitting the first message, the UE may receive MBS configuration parameters and/or information required to receive data associated with the MBS services using the target cell. In a 4-step random access process, receiving the MBS configuration parameters and/or information required to receive data associated with the MBS services using the target cell may be a Msg4. In a 2-step random access process, receiving the MBS configuration parameters and/or information required to receive data associated with the MBS services using the target cell may be a MsgB. In some examples, the UE may receive the receive MBS configuration parameters and/or information required to receive data associated with the MBS services from a cell that the UE is currently camped on. In some examples, the UE may receive the receive MBS configuration parameters and/or information required to receive data associated with the MBS services from the target cell.

The UE may receive the MBS configuration parameters and/or information required to receive data associated with the MBS services using the target cell as part of an RRC reject message indicating remaining in the RRC inactive/idle state. For example, the RRC reject message may comprise a suspend config information element indicating remaining/transitioning in the RRC inactive state and comprising MBS configuration parameters and/or information required to receive data associated with the MBS services using the target cell. In some examples, the MBS configuration parameters and/or information required to receive data associated with the MBS services using the target cell may indicate and/or may comprise service identifiers (e.g., TMGIs, etc.) of one or more MBS services provided by the target cell and/or may indicate one or more MBS services that are admitted by the target cell. The admitted MBS services may be a subset of the MBS services indicated/requested by the first message. In some examples, the MBS configuration parameters and/or information required to receive data associated with the MBS services using the target cell may comprise first configuration parameters for receiving control information (e.g., via an MCCH) for receiving the MBS data from the target cell. The first configuration parameters may comprise scheduling information (e.g., periodicity of control information transmission by the target cell, etc.) for receiving the control information. In some examples, the MBS configuration parameters and/or information required to receive data associated with the MBS services using the target cell may comprise a BWP identifier of the target cell for receiving the control information and/or data for the MBS services, a numerology associated with the MBS services (e.g., a numerology for MBS data/control reception), a control resource set (CORESET) for receiving scheduling information for MBS data/control, etc.

The UE may receive data associated with the MBS services via the target cell using the MBS configuration parameters and/or the information. The UE may remain in the RRC idle state or the RRC inactive state and may not transition to the RRC connected state.

In an embodiment, a user equipment (UE) in a radio resource control (RRC) state, may receive a broadcast message comprising measurement configuration parameters, wherein the RRC state may be one of an RRC inactive state and an RRC idle state. The UE may determine, based on the measurement configuration parameters, a service continuity trigger for one or more multicast broadcast services (MBS) services. In response to determining the service continuity trigger for the one or more MBS services, the UE may start a random access process comprising transmitting a first message indicating a request for MBS configuration parameters associated with the one or more MBS services via a target cell. The UE may receive the one or more MBS configuration parameters based on transmitting the first message. The UE may receive data associated with the one or more MBS services via the target cell based on the MBS configuration parameters and while remaining in the RRC state.

In some embodiments, the broadcast message may be a system information block (SIB) message.

In some embodiments, the measurement configuration parameters may comprise one or more of one or more thresholds, one or more carrier frequencies for measurement, one or more frequency band lists, one or more beam related measurement parameters, one or more durations for measurement, one or more lists of cells for measurement, and a number of synchronization signal blocks (SSBs) for cell measurement derivation.

In some embodiments, the determining the service continuity trigger may be based on measuring one or more SSBs and comparing the received signal strengths of the one or more SSBs with one or more thresholds.

In some embodiments, the first message may comprise a cause field, a value of the cause field indicating at least one of: the first message is transmitted due to the service continuity trigger; and the first message is transmitted to request the MBS configuration parameters.

In some embodiments, the UE may be in the RRC inactive state; the first message may be an RRC resume request message; and values of one or more fields in the RRC resume request message indicate the request for the one or more MBS configuration parameters while remaining in the RRC inactive state. In some embodiments, the one or more fields may comprise a resume cause field. In some embodiments, the receiving the one or more MBS configuration parameters may be via an RRC reject message indicating remaining in the RRC inactive state.

In some embodiments, the one or more MBS configuration parameters may comprise one or more first parameters for receiving control information, associated with the one or more MBS services, via the target cell.

In some embodiments, the one or more MBS configuration parameters may comprise at least one of a bandwidth part identifier, a control resource set and a numerology associated with the one or more MBS services.

In some embodiments, the first message may comprise one or more service identifiers associated with one or more MBS services provided by a current cell that the UE is camped on. In some embodiments, the one or more MBS configuration parameters may indicate one or more first service identifiers of the one or more MBS service identifiers, wherein the one or more first service identifiers are provided by the target cell.

In some embodiments, a quality of service associated with an MBS bearer associated with an MBS service of the one or more MBS services may indicate a level of service continuity requirement for the MBS bearer.

In some embodiments, a random access preamble transmitted during the random access process may indicate that the random access process is associated with an MBS service continuity.

In some embodiments, the transmitting the first message may be via a Message-3 in a four-step random access process. In some embodiments, the receiving the one or more MBS configuration parameters may be via a Message-4 in the four-step random access process.

In some embodiments, the transmitting the first message is via a Message-A in a two-step random access process. In some embodiments, the receiving the one or more MBS configuration parameters may be via a Message-B in the two-step random access process.

In some embodiments, the UE may receive an RRC release message indicating a transition to the RRC inactive state or the RRC idle state, wherein the RRC release message may comprise one or more MBS service continuity parameters. In some embodiments, the RRC release message ma comprises a suspend config information element indicating the transition to the RRC inactive state and comprising the one or more MBS service continuity parameters. In some embodiments, the transmitting the first message may be based on the one or more MBS service continuity parameters.

The exemplary blocks and modules described in this disclosure with respect to the various example embodiments may be implemented or performed with a general-purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. Examples of the general-purpose processor include but are not limited to a microprocessor, any conventional processor, a controller, a microcontroller, or a state machine. In some examples, a processor may be implemented using a combination of devices (e.g., a combination of a DSP and a microprocessor, multiple microprocessors, one or more microprocessors in conjunction with a DSP core, or any other such configuration).

The functions described in this disclosure may be implemented in hardware, software executed by a processor, firmware, or any combination thereof. Instructions or code may be stored or transmitted on a computer-readable medium for implementation of the functions. Other examples for implementation of the functions disclosed herein are also within the scope of this disclosure. Implementation of the functions may be via physically co-located or distributed elements (e.g., at various positions), including being distributed such that portions of functions are implemented at different physical locations.

Computer-readable media includes but is not limited to non-transitory computer storage media. A non-transitory storage medium may be accessed by a general purpose or special purpose computer. Examples of non-transitory storage media include, but are not limited to, random access memory (RAM), read-only memory (ROM), electrically erasable programmable ROM (EEPROM), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable media.

As used in this disclosure, use of the term “or” in a list of items indicates an inclusive list. The list of items may be prefaced by a phrase such as “at least one of” or “one or more of”. For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification the terms “comprise”, “include” or “contain” may be used interchangeably and have the same meaning and are to be construed as inclusive and open-ending. The terms “comprise”, “include” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

Clause 1. A method of maintaining service continuity comprising:
receiving, by a user equipment (UE) in a radio resource control (RRC) state, a broadcast message comprising measurement configuration parameters, wherein the RRC state corresponds to at least one of an RRC inactive state and an RRC idle state;
determining, based on the measurement configuration parameters, a service continuity trigger for one or more multicast broadcast services (MBS) services;
based on the determined service continuity trigger, initiating a random access process (RAP), wherein initiating the RAP includes transmitting a first message indicating a request for MBS configuration parameters associated with the one or more MBS services;
receiving the one or more MBS configuration parameters in response to transmitting the first message; and
receiving data associated with the one or more MBS services via the target cell based on the MBS configuration parameters and while remaining in the RRC state.

Clause 2. The method of Clause 1, wherein the broadcast message is a system information block (SIB) message.

Clause 3. The method of Clause 1, wherein the measurement configuration parameters comprise at least one of one or more thresholds, carrier frequencies for measurement, frequency band lists, beam related measurement parameters, durations for measurement, lists of cells for measurement, and a number of synchronization signal blocks (SSBs) for cell measurement derivation.

Clause 4. The method of Clause 1, wherein determining the service continuity trigger comprises measuring one or more synchronization signal blocks (SSBs) and comparing the received signal strengths of the one or more SSBs with one or more thresholds.

Clause 5. The method of Clause 1, wherein the first message includes a cause field having information including at least one of:
the first message is transmitted in response to the service continuity trigger; and
the first message is transmitted to request the multicast broadcast services (MBS) configuration parameters.

Clause 6. The method of Clause 1, wherein the radio resource control (RRC) corresponds to an inactive state, wherein the first message is an RRC resume request message, wherein values of one or more fields in the RRC resume request message indicates the request for the one or more multicast broadcast services (MBS) configuration parameters while remaining in the RRC inactive state.

Clause 7. The method of Clause 6, wherein the one or more fields comprise a resume cause field.

Clause 8. The method of Clause 6, wherein receiving the one or more multicast broadcast services (MBS) configuration parameters include receiving a radio resource control (RRC) reject message corresponding to an instruction to remain in the RRC inactive state.

Clause 9. The method of Clause 1, wherein the one or more multicast broadcast services (MBS) configuration parameters comprise one or more first parameters for receiving control information.

Clause 10. The method of Clause 1, wherein the one or more multicast broadcast services (MBS) configuration parameters comprise at least one of a bandwidth part identifier, a control resource set and a numerology associated with the one or more MBS services.

Clause 11. The method of Clause 1, wherein the first message comprises one or more service identifiers associated with one or more multicast broadcast services (MBS) services provided by a current cell that the user equipment (UE) is camped on.

Clause 12. The method of Clause 11, wherein the one or more multicast broadcast services (MBS) configuration parameters indicate one or more first service identifiers of the one or more MBS service identifiers, and wherein the one or more first service identifiers associated with a target cell.

Clause 13. The method of Clause 1, wherein a quality of service (QoS) associated with a multicast broadcast services (MBS) bearer associated with an MBS service of the one or more MBS services indicates a level of service continuity requirement for the MBS bearer.

Clause 14. The method of Clause 1, wherein the random access process comprises transmitting a random access preamble to indicate that the random access process is associated with an multicast broadcast services (MBS) service continuity.

Clause 15. The method of Clause 1, wherein transmitting the first message includes transmitting the first message via a Message-3 four-step random access process.

Clause 16. The method of Clause 15, wherein the receiving the one or more multicast broadcast services (MBS) configuration parameters include receiving the MBS configuration parameters via a Message-4 four-step random access process.

Clause 17. The method of Clause 1, wherein transmitting the first message includes transmitting the first message via a Message-A two-step random access process.

Clause 18. The method of Clause 17, wherein the one or more multicast broadcast services (MBS) configuration parameters include receiving the MBS configuration parameters via a Message-B in the two-step random access process.

Clause 19. The method of Clause 1 further comprising receiving a radio resource control (RRC) release message indicating a transition to the RRC inactive state or the RRC idle state, wherein the RRC release message comprises one or more multicast broadcast services (MBS) service continuity parameters.

Clause 20. The method of Clause 19, wherein the radio resource control (RRC) release message comprises a suspend config information element indicating the transition to the RRC inactive state and comprising the one or more multicast broadcast services (MBS) service continuity parameters.

Clause 21. The method of Clause 19 wherein the transmitting the first message is based on the one or more multicast broadcast services (MBS) service continuity parameters.

Clause 22. An apparatus for utilization in wireless communications comprising:
an antenna for use in transmission of electromagnetic signals;
a memory for maintaining computer-readable code; and
a processor for executing the computer-readable code that causes the apparatus to:
receive measurement (UE) in a radio resource control (RRC) state, a broadcast message comprising measurement configuration parameters, wherein the RRC state corresponds to at least one of an RRC inactive state and an RRC idle state;
determine, based on the measurement configuration parameters, a service continuity trigger for one or more multicast broadcast services (MBS) services;
responsive to the determined service continuity trigger, initiate a random access process (RAP), wherein initiating the RAP includes transmitting a first message indicating a request for MBS configuration parameters associated with the one or more MBS services;
receive the one or more MBS configuration parameters in response to transmitting the first message; and
receive data associated with the one or more MBS services via the target cell based on the MBS configuration parameters and while remaining in the RRC state.

Clause 23. The apparatus of Clause 22, wherein the broadcast message is a system information block (SIB) message.

Clause 24. The apparatus of Clause 22, wherein the measurement configuration parameters comprise at least one of one or more thresholds, carrier frequencies for measurement, frequency band lists, beam related measurement parameters, durations for measurement, lists of cells for measurement, and a number of synchronization signal blocks (SSBs) for cell measurement derivation.

Clause 24. The method of Clause 22, wherein determining the service continuity trigger comprises measuring one or more synchronization signal blocks (SSBs) and comparing the received signal strengths of the one or more SSBs with one or more thresholds.

Clause 25.—The apparatus of Clause 22, wherein the first message includes an information including an indication that at least one of the first message is transmitted in response to the service continuity trigger or the first message is transmitted to request the multicast broadcast services (MBS) configuration parameters.

Clause 26. The apparatus of Clause 22, wherein the radio resource control (RRC) corresponds to an inactive state, wherein the first message is an RRC resume request message, and wherein values of one or more fields in the RRC resume request message indicate the request for the one or more multicast broadcast services (MBS) configuration parameters while remaining in the RRC inactive state.

Clause 27. The apparatus of Clause 26, wherein the one or more fields comprise a resume cause field.

Clause 28. The apparatus of Clause 26, wherein receiving the one or more multicast broadcast services (MBS) configuration parameters include receiving a radio resource control (RRC) reject message corresponding to an instruction to remain in the RRC inactive state.

Clause 29. The apparatus of Clause 22, wherein the one or more multicast broadcast services (MBS) configuration parameters comprise one or more first parameters for receiving control information.

Clause 30. The apparatus of Clause 22, wherein the one or more multicast broadcast services (MBS) configuration parameters comprise at least one of a bandwidth part identifier, a control resource set and a numerology associated with the one or more MBS services.

Clause 31. The apparatus of Clause 22, wherein the first message comprises one or more service identifiers associated with one or more multicast broadcast services (MBS) services provided by a current cell that the user equipment (UE) is camped on.

Clause 32. The apparatus of Clause 31, wherein the one or more multicast broadcast services (MBS) configuration parameters indicate one or more first service identifiers of the one or more MBS service identifiers, and wherein the one or more first service identifiers associated with a target cell.

Clause 33. The apparatus of Clause 22, wherein a quality of service (QoS) associated with a multicast broadcast services (MBS) bearer associated with an MBS service of the one or more MBS services indicates a level of service continuity requirement for the MBS bearer.

Clause 34. The apparatus of Clause 22, wherein the random access process comprises transmitting a random access preamble to indicate that the random access process is associated with a multicast broadcast services (MBS) service continuity.

Clause 35. The apparatus of Clause 22, wherein the apparatus transmits the first message according to a random access process.

Clause 36. The apparatus of Clause 22, wherein the apparatus is further configured to transmit a radio resource control (RRC) release message indicating a transition to the RRC inactive state or the RRC idle state, wherein the RRC release message comprises one or more multicast broadcast services (MBS) service continuity parameters. apparatus

Clause 37. The apparatus of Clause 36, wherein the radio resource control (RRC) release message comprises a suspend config information element indicating the transition to the RRC inactive state and comprising the one or more multicast broadcast services (MBS) service continuity parameters.

Clause 38. A method of maintaining service continuity comprising:
transmitting, to a user equipment (UE) in a radio resource control (RRC) state, a broadcast message comprising measurement configuration parameters, wherein the RRC state of the UE corresponds to at least one of an RRC inactive state and an RRC idle state;
receiving, from the UE, a first message indicating a request for MBS configuration parameters associated with the one or more MBS services;
transmitting, to the UE, the one or more MBS configuration parameters in response to transmitting the first message; and
transmitting data associated with the one or more MBS services via the target cell based on the MBS configuration parameters and while remaining in the RRC state.

Clause 39. The method of Clause 38, wherein the broadcast message is a system information block (SIB) message.

Clause 40. The method of Clause 38, wherein the measurement configuration parameters comprise at least one of one or more thresholds, carrier frequencies for measurement, frequency band lists, beam related measurement parameters, durations for measurement, lists of cells for measurement, and a number of synchronization signal blocks (SSBs) for cell measurement derivation.

Clause 41. The method of Clause 38, wherein the first message includes a cause field having information including an indication that at least one of the first message is transmitted in response to the service continuity trigger or the first message is transmitted to request the multicast broadcast services (MBS) configuration parameters.

Clause 42. The method of Clause 38, wherein the radio resource control (RRC) corresponds to an inactive state, wherein the first message is an RRC resume request message, wherein values of one or more fields in the RRC resume request message indicate the request for the one or more multicast broadcast services (MBS) configuration parameters while remaining in the RRC inactive state.

Clause 43. The method of Clause 38, wherein transmitting the one or more multicast broadcast services (MBS) configuration parameters include transmitting a radio resource control (RRC) reject message corresponding to an instruction to remain in the RRC inactive state.

Clause 44. The method of Clause 38, wherein the one or more multicast broadcast services (MBS) configuration parameters comprise one or more first parameters for receiving control information.

Clause 45. The method of Clause 38, wherein the one or more multicast broadcast services (MBS) configuration parameters comprise at least one of a bandwidth part identifier, a control resource set and a numerology associated with the one or more MBS services.

Clause 46. The method of Clause 38, wherein the first message comprises one or more service identifiers associated with one or more multicast broadcast services (MBS) services provided by a current cell that the user equipment (UE) is camped on.

Clause 47. The method of Clause 38, wherein the one or more multicast broadcast services (MBS) configuration parameters indicate one or more first service identifiers of the one or more MBS service identifiers, and wherein the one or more first service identifiers associated with a target cell.

Clause 48. The method of Clause 38, wherein a quality of service (QoS) associated with a multicast broadcast services (MBS) bearer associated with an MBS service of the one or more MBS services indicates a level of service continuity requirement for the MBS bearer.

Clause 49. The method of Clause 38, wherein the random access process comprises transmitting a random access preamble to indicate that the random access process is associated with a multicast broadcast services (MBS) service continuity.

Clause 50. The method of Clause 38, wherein transmitting the first message includes transmitting the first message in accordance with a random access process.

Clause 51. The method of Clause 38 further comprising transmitting a radio resource control (RRC) release message indicating a transition to the RRC inactive state or the RRC idle state, wherein the RRC release message comprises one or more multicast broadcast services (MBS) service continuity parameters.

Clause 52. The method of Clause 51, wherein the radio resource control (RRC) release message comprises a suspend config information element indicating the transition to the RRC inactive state and comprising the one or more multicast broadcast services (MBS) service continuity parameters.

Clause 53. An apparatus for utilization in wireless communications comprising:
an antenna for use in transmission of electromagnetic signals;
a memory for maintaining computer-readable code; and
a processor for executing the computer-readable code that causes the apparatus to:

receive measurement (UE) in a radio resource control (RRC) state, a broadcast message comprising measurement configuration parameters, wherein the RRC state of the UE corresponds to at least one of an RRC inactive state and an RRC idle state; receive from the UE, a first message indicating a request for MBS configuration parameters associated with the one or more MBS services;
transmit to the UE, the one or more MBS configuration parameters in response to transmitting the first message; and
transmit data associated with the one or more MBS services via the target cell based on the MBS configuration parameters and while remaining in the RRC state.

Clause 54. The apparatus of Clause 53, wherein the broadcast message is a system information block (SIB) message.

Clause 55. The apparatus of Clause 53, wherein the measurement configuration parameters comprise at least one of one or more thresholds, carrier frequencies for measurement, frequency band lists, beam related measurement parameters, durations for measurement, lists of cells for measurement, and a number of synchronization signal blocks (SSBs) for cell measurement derivation.

Clause 56. The apparatus of Clause 53, wherein the first message includes a cause field having information including an indication that at least one of the first message is transmitted in response to the service continuity trigger or the first message is transmitted to request the multicast broadcast services (MBS) configuration parameters.

Clause 57. The apparatus of Clause 53, wherein the radio resource control (RRC) corresponds to an inactive state, wherein
the first message is an RRC resume request message, wherein
values of one or more fields in the RRC resume request message indicate the request for the one or more multicast broadcast services (MBS) configuration parameters while remaining in the RRC inactive state.

Clause 58. The apparatus of Clause 42, wherein the apparatus is further configured to transmit a radio resource control (RRC) reject message corresponding to an instruction to remain in the RRC inactive state.

Clause 59. The apparatus of Clause 53, wherein the one or more multicast broadcast services (MBS) configuration parameters comprise one or more first parameters for receiving control information.

Clause 60. The apparatus of Clause 53, wherein the one or more multicast broadcast services (MBS) configuration parameters comprise at least one of a bandwidth part identifier, a control resource set and a numerology associated with the one or more MBS services.

Clause 61. The apparatus of Clause 53, wherein the first message comprises one or more service identifiers associated with one or more multicast broadcast services (MBS) services provided by a current cell that the user equipment (UE) is camped on.

Clause 62. The apparatus of Clause 53, wherein the one or more multicast broadcast services (MBS) configuration parameters indicate one or more first service identifiers of the one or more MBS service identifiers, and wherein the one or more first service identifiers associated with a target cell.

Clause 63. The apparatus of Clause 53, wherein a quality of service (QoS) associated with a multicast broadcast services (MBS) bearer associated with an MBS service of the one or more MBS services indicates a level of service continuity requirement for the MBS bearer.

Clause 64. The apparatus of Clause 53, wherein the random access process comprises transmitting a random access preamble to indicate that the random access process is associated with a multicast broadcast services (MBS) service continuity.

Clause 65. The apparatus of Clause 53, wherein the apparatus is further configured to transmit the first message in accordance with a random access process.

Clause 66. The apparatus of Clause 53, wherein the apparatus is further configured transmit a radio resource control (RRC) release message indicating a transition to the RRC inactive state or the RRC idle state, wherein the RRC release message comprises one or more multicast broadcast services (MBS) service continuity parameters.

Clause 67. The apparatus of Clause 51, wherein the radio resource control (RRC) release message comprises a suspend config information element indicating the transition to the RRC inactive state and comprising the one or more multicast broadcast services (MBS) service continuity parameters.

This application claims the benefit of U.S. Provisional Application No. 63/076,704, entitled “SYSTEM AND METHOD FOR MAINTAINING MULTICAST BROADCAST SERVICE CONTINUITY IN IDLE AND INACTIVE STATES”, and filed on Sep. 10, 2020. U.S. Provisional Application No. 63/076,704 is incorporated by reference herein.

1-36. (canceled)

37. A method of maintaining service continuity comprising:
receiving, by a user equipment (UE) in a radio resource control (RRC) state, a broadcast message comprising measurement configuration parameters, wherein the RRC state corresponds to at least one of an RRC inactive state and an RRC idle state;
determining, based on the measurement configuration parameters, a service continuity trigger for one or more multicast broadcast services (MBS) services;
based on the determined service continuity trigger, initiating a random access process (RAP), wherein initiating the RAP includes transmitting a first message indicating a request for MBS configuration parameters associated with the one or more MBS services;
receiving the one or more MBS configuration parameters in response to transmitting the first message; and
receiving data associated with the one or more MBS services via the target cell based on the MBS configuration parameters and while remaining in the RRC state.

38. The method of claim 37, wherein the broadcast message is a system information block (SIB) message.

39. The method of claim 37, wherein the measurement configuration parameters comprise at least one of one or more thresholds, carrier frequencies for measurement, frequency band lists, beam related measurement parameters, durations for measurement, lists of cells for measurement, and a number of synchronization signal blocks (SSBs) for cell measurement derivation.

40. The method of claim 37, wherein determining the service continuity trigger comprises measuring one or more synchronization signal blocks (SSBs) and comparing the received signal strengths of the one or more SSBs with one or more thresholds.

41. The method of claim 37, wherein the first message includes a cause field having information including at least one of:
the first message is transmitted in response to the service continuity trigger; and
the first message is transmitted to request the multicast broadcast services (MBS) configuration parameters.

42. The method of claim 37, wherein the radio resource control (RRC) corresponds to an inactive state, wherein the first message is an RRC resume request message, wherein values of one or more fields in the RRC resume request message indicate the request for the one or more multicast broadcast services (MBS) configuration parameters while remaining in the RRC inactive state.

43. The method of claim 42, wherein the one or more fields comprise a resume cause field.

44. The method of claim 42, wherein receiving the one or more multicast broadcast services (MBS) configuration parameters includes receiving a radio resource control (RRC) reject message corresponding to an instruction to remain in the RRC inactive state.

45. The method of claim 37, wherein the one or more multicast broadcast services (MBS) configuration parameters comprise one or more first parameters for receiving control information.

46. The method of claim 37, wherein the one or more multicast broadcast services (MBS) configuration parameters comprise at least one of a bandwidth part identifier, a control resource set and a numerology associated with the one or more MBS services.

47. The method of claim 37, wherein the first message comprises one or more service identifiers associated with one or more multicast broadcast services (MBS) services provided by a current cell that the user equipment (UE) is camped on.

48. The method of claim 47, wherein the one or more multicast broadcast services (MBS) configuration parameters indicate one or more first service identifiers of the one or more MBS service identifiers, and wherein the one or more first service identifiers associated with a target cell.

49. The method of claim 37, wherein a quality of service (QoS) associated with an multicast broadcast services (MBS) bearer associated with an MBS service of the one or more MBS services indicates a level of service continuity requirement for the MBS bearer.

50. The method of claim 37, wherein the random access process comprises transmitting a random access preamble to indicate that the random access process is associated with an multicast broadcast services (MBS) service continuity.

51. The method of claim 37, wherein transmitting the first message includes transmitting the first message via a Message-3 four-step random access process.

52. The method of claim 51, wherein the receiving the one or more multicast broadcast services (MBS) configuration parameters includes receiving the MBS configuration parameters via a Message-4 four-step random access process.

53. The method of claim 37, wherein transmitting the first message includes transmitting the first message via a Message-A two-step random access process.

54. The method of claim 53, wherein the one or more multicast broadcast services (MBS) configuration parameters includes receiving the MBS configuration parameters via a Message-B in the two-step random access process.

55. The method of claim 37, further comprising receiving a radio resource control (RRC) release message indicating a transition to the RRC inactive state or the RRC idle state, wherein the RRC release message comprises one or more multicast broadcast services (MBS) service continuity parameters.

56. A method of maintaining service continuity comprising:
transmitting, to a user equipment (UE) in a radio resource control (RRC) state, a broadcast message comprising measurement configuration parameters, wherein the RRC state of the UE corresponds to at least one of an RRC inactive state and an RRC idle state;
receiving, from the UE, a first message indicating a request for MBS configuration parameters associated with the one or more MBS services;
transmitting, to the UE, the one or more MBS configuration parameters in response to transmitting the first message; and
transmitting data associated with the one or more MBS services via the target cell based on the MBS configuration parameters and while remaining in the RRC state.
